(19) United States
(12) Patent Application Publication
(10) Pub. No.: US 2026/0240204 A1
(43) Pub. Date: Aug. 20, 2026

(54) COMPOSITE SYSTEMS AND USE THEREOF

(71) Applicant: BETTER JUICE LTD., Ness Ziona (IL)

(72) Inventors: Gali YAROM, Givataim (IL); Eran BLACHINSKY, Kibbutz Harel (IL); Arad DAVID, Ariel (IL)

(73) Assignee: BETTER JUICE LTD., Ness Ziona (IL)

(21) Appl. No.: 19/517,580

(22) PCT Filed: May 30, 2024
(86) PCT No.: PCT/IL2024/050530

§ 371 Date: Mar. 9, 2026

Related U.S. Application Data
(60) Provisional application No. 63/505,448, filed on Jun. 1, 2023.

(51) Int. Cl. A23L 2/84; A23L 2/02; A23L 29/256

(52) U.S. Cl. CPC A23L 2/84; A23L 2/02; A23L 29/256

(57) ABSTRACT

The present invention provides composite systems comprising a plurality of enzymatically active non-proliferating microbial cells immobilized to a support for sugar reduction and optionally dietary fiber content elevation in fruit or vegetable juice containing various types of sugars, providing for an industrial scale, efficient, continuous, and stable process.

### FIELD OF THE INVENTION

The present invention provides composite systems comprising a plurality of enzymatically active non-proliferating microbial cells immobilized to a support for sugar reduction and optionally dietary fiber content elevation in fruit or vegetable juice containing various types of sugars, providing for an industrial scale, efficient, continuous, and stable process.

### BACKGROUND OF THE INVENTION

Concerns about consumption of sugar-containing beverages and its impact on the obesity and chronic disease epidemic in the USA have taken center stage over the last decade. Today, Americans consume 150-300 more calories per day than they did 30 years ago, and caloric beverages account for about 50% of this increase. When consuming liquids compared to solid foods, more postprandial hunger, less fullness, more rapid gastric emptying, lower release of insulin and glucagon-like peptide 1, and attenuated suppression of the appetite-stimulating hormone ghrelin have been reported, all factors known to result in a weaker satiety response.

Fruit juice may contain about the same amount of sugar as in soft drinks, even without sugar addition. The monosaccharides glucose and fructose are the main contributors to the calorie content in the juice. However, while glucose stimulates the release of body chemicals (e.g., insulin) that regulate food intake, fructose does little to suppress appetite and it seems to be preferentially associated with the formation of new fat cells. In contrast, dietary fibers like cellulose, hemicellulose, pectin, gums, mucilage, and lignin are known as satiety promoters due to their resistance to breakdown by the human digestive system. Bioconversion of the mono- and disaccharides (glucose, fructose, and sucrose) to at least one of oligosaccharide/polysaccharide, sugar alcohol and/or gluconic acid can be achieved by some plants, fungi and some bacteria comprising certain enzymes such as cellulose synthases, glucosyltransferases, oxidoreductases, fructosyltransferases, glucose oxidases, and glucose isomerases.

Cell entrapment, for example microorganism entrapment, in which cells are included within a rigid network, is the most widely used technique for whole cell immobilization. This rigid network is porous enough to allow the diffusion of substrates and products, protects the selected microorganism from the reaction medium, and has high immobilization efficiency (Trelles, J. A., Rivero, C. W., Whole Cell Entrapment Techniques, Methods in Molecular Biology, vol 1051, 2013). This methodology typically additionally requires introduction of cross-linking agents to strengthen the cell trap.

An inventor of the present invention and co-workers have previously described a process for reducing the sugar content in food products, particularly in juice obtained from fruit or vegetables and enriching the food product with dietary fibers using non-viable microbial cells, and low sugar, high fiber food product produced by same (PCT Application Publication No. WO 2018/078623).

However, there remain a need for means and processes for obtaining low-sugar juice beverages which are applicable to industrial scale, efficient, continuous, and stable.

### SUMMARY OF THE INVENTION

The present invention answers the above-described need, providing a system for juice processing, particularly for reducing the content of mono- and/or disaccharides and optionally elevating the content of dietary fibers within natural juice and products thereof, which is operable under industrial-scale conditions at a highly efficient manner.

The present invention is based in part on the unexpected discovery that a composite system comprising enzymatically active non-proliferating microbial cells immobilized to a support formed from solidified carrageenan gel is physically and chemically stable for a prolonged period of at least 30 days and up to 90 days and more when exposed to pH changes within a solution, particularly fruit or vegetable juice which is titrated to change its acidic starting pH of about 5.0 to a basic pH of up to 8.0.

According to certain aspects of the present invention, there is provided an enzymatically active composite system comprising a plurality of enzymatically active non-proliferating microbial cells immobilized to a support, wherein the support is substantially water insoluble at 25° C. and comprises:
an anionic polymer comprising a polymeric backbone bonded to a plurality of negatively charged functional groups selected from the group consisting of: carboxylate, sulfate, and sulfonate; and potassium countercations,
   wherein the potassium cations and the negatively charged functional groups are at a ratio of at least 1:2.

According to certain embodiments, the support is in the form of a solidified hardened substantially water insoluble gel at 25° C.

According to certain embodiments, the anionic polymer solidifies in the presence of potassium cations to form the substantially water insoluble support.

According to certain embodiments, the negatively charged functional groups comprise a plurality of sulfate groups.

According to certain embodiments, the anionic polymer comprises a plurality of potassium sulfate groups, at a weight ratio in the range of 20% to 40% w/w based on the total polymer weight.

According to certain embodiments, the polymeric backbone comprises a plurality of sugar monomers. In another embodiment, the polymeric backbone comprises a plurality of monomers selected from the group consisting of: galactose monomers and anhydro galactose monomers.

According to certain embodiments, the anionic polymer is an anionic polysaccharide.

According to certain embodiments, the anionic polysaccharide comprises a sulfate group per 1.5 to 2.5 sugar monomers.

According to certain embodiments, the anionic polysaccharide is carrageenan. In another embodiment, the anionic polysaccharide is kappa carrageenan.

According to certain embodiments, the support further comprises a stabilizer. According to certain embodiments, the stabilizer is selected from the group consisting of xanthan gum, gellan gum, and guar gum.

According to certain exemplary embodiments, the support comprises carrageenan and xanthan gum.

According to certain embodiments, the composite system maintains the form of solidified hardened gel within a solution having a pH in the range of 5 to 8 at a temperature of from about 0° C. up to about 65° C.

According to certain embodiments, the composite system is in the form of beads.

According to certain embodiments, at least 90% of the beads maintain the form of solidified hardened gel within a solution having a pH in the range of 5 to 8 at a temperature of from about 0° C. up to about 65° C.

According to certain embodiments, the composite system is stable within a solution having a pH in the range of 5 to 8 at a temperature of up to 37° C.

According to certain embodiments, the composite system maintains the form of solidified hardened gel within a solution having a pH in the range of 5 to 8 at a temperature of up to 37° C.

According to certain embodiments, at least 90% of the beads are stable within a solution having a pH in the range of 5 to 8 at a temperature of up to 37° C. According to certain embodiments, at least 90% of the beads maintain the form of solidified hardened gel within a solution having a pH in the range of 5 to 8 at a temperature of up to 37° C.

According to certain embodiments, the composite system is stable for at least two months when kept at a temperature of from about 20° C. to about 30° C.

According to certain embodiments, the composite system is stable within a solution having a pH in the range of from about 5 to about 8 and a temperature of from 20° C. to 30° C. for at least two months. According to certain embodiments, the composite system maintains the form of solidified hardened gel within a solution having a pH in the range of from about 5 to about 8 and a temperature of from 20° C. to 30° C. for at least two months.

According to certain embodiments, at least 90% of the beads are stable within a solution having a pH in the range of from about 5 to about 8 and a temperature of from 20° C. to 30° C. for at least two months. According to certain embodiments, at least 90% of the beads maintain the form of solidified hardened gel within a solution having a pH in the range of from about 5 to about 8 and a temperature of from 20° C. to 30° C. for at least two months.

According to further embodiments, the composite system is stable for at least six months when kept at a temperature of from about 0° C. to about 8° C.

According to certain embodiments, the composite system is stable within a solution having a pH in the range of from about 5 to about 8 and a temperature of from 0° C. to 8° C. for at least six months. According to certain embodiments, the composite system maintains the form of solidified hardened gel within a solution having a pH in the range of from about 5 to about 8 and a temperature of from 0° C. to 8° C. for at least six months.

According to certain embodiments, at least 90% of the beads are stable within a solution having a pH in the range of from about 5 to about 8 and a temperature of from 0° C. to 8° C. for at least six months. According to certain embodiments, at least 90% of the beads maintain the form of solidified hardened gel within a solution having a pH in the range of from about 5 to about 8 and a temperature of from 0° C. to 8° C. for at least six months.

According to certain embodiments, the solution comprises fruit or vegetable juice. It is to be explicitly understood that the term “fruit or vegetable juice” is as defined hereinbelow.

According to certain embodiments, the solution comprises at least one preservative.

According to certain embodiments, the solution comprises fruit or vegetable juice and at least one preservative. According to certain embodiments, the preservative is a food-grade preservative.

According to certain embodiments, the plurality of enzymatically active non-proliferating microbial cells comprises non-proliferating bacterial cells, non-proliferating fungal cells or a combination thereof.

According to certain embodiments, the plurality of enzymatically active non-proliferating microbial cells catalyzes a transformation of monosaccharides, disaccharides, or both into at least one of sugar alcohol, a sugar acid, an oligosaccharide, a polysaccharide, or a combination thereof. In another embodiment, the plurality of enzymatically active non-proliferating microbial cells catalyze a transformation of glucose, fructose, sucrose, or a combination thereof into at least one of sorbitol and gluconic acid. In another embodiment, the plurality of enzymatically active non-proliferating microbial cells catalyze a transformation of sucrose to fructooligosaccharides (FOS).

According to certain embodiments, the plurality of enzymatically active non-proliferating microbial cells comprises an enzyme selected from the group consisting of cellulose synthase, glucosyltransferase, oxidoreductases, fructosyltransferase, glucose oxidase, glucose isomerase and any combination thereof. In another embodiment, the plurality of enzymatically active non-proliferating microbial cells comprises an enzyme selected from the group consisting of glucose fructose oxidase reductase (GFOR), glucose oxidase (GOX), sucrose fructosyltransferase (SFTase) or a combination thereof.

According to certain embodiments, the plurality of enzymatically active non-proliferating microbial cells comprises microbial cells selected from the group consisting of Zymomonas mobilis (ZM), Aspergillus japonicus (AJ) Aspergillus niger (AN) and any combination thereof.

According to certain embodiments, the plurality of enzymatically active non-proliferating microbial cells consists of ZM cells.

According to certain embodiments, the plurality of enzymatically active non-proliferating microbial cells consists of AJ cells.

According to certain embodiments, the plurality of enzymatically active non-proliferating microbial cells consists of AN cells.

According to certain additional aspects of the present invention there is provided a combination of at least two composite systems, wherein each of the composite systems comprises a plurality of enzymatically active non-proliferating microbial cells of a distinct species. According to certain embodiments, each of the composite systems comprises a plurality of enzymatically active non-proliferating microbial cells of a distinct, single species.

According to certain embodiments, the combination comprises a composite system comprising a plurality of non-proliferating Zymomonas mobilis (ZM) cells (ZM composite system) and a composite system comprising a plurality of non-proliferating Aspergillus japonicus (AJ) cells (AJ composite system).

According to certain embodiments, the ratio of ZM composite system to AJ composite system is the range of 60:40 to 90:10 w/w based on the total weight of the combination.

In yet further certain aspects of the present invention there is provided a process for reducing the content of at least one mono- and/or disaccharide in a fruit or vegetable juice comprising contacting a starting juice product with at least one composite system of the invention for an operation period of at least 30 days, thereby reducing the content of the at least one mono- and/or disaccharide by at least 5%.

According to certain embodiments, the pH of the starting juice product is below 5.5. According to these embodiments, the process further comprises titrating the juice to a pH of about 7.0 throughout the process.

According to certain embodiments, the operation period is at least 35 days, at least 40 days, at least 45 days, at least 50 days, at least 55 days, at least 60 days, at least 60 days, at least 65 days, at least 70 days, at least 75 days, at least 80 days, at least 85 days, or at least 90 days.

According to certain embodiments, the composite system is stable throughout the operation period.

According to certain exemplary embodiments, the process comprises contacting the starting juice product with a combination of a composite system comprising a plurality of non-proliferating microbial cells comprising at least one glucose fructose oxidoreductase (GFOR) and a composite system comprising a plurality of non-proliferating cells microbial cells comprising at least one sucrose fructosyltransferase (SFTase), thereby transforming the mono- and/or disaccharide of said starting juice to at least one oligo- and/or polysaccharide, a sugar alcohol, and a sugar acid.

According to further certain exemplary embodiments, the process comprises contacting the starting juice product with a combination of a composite system comprising a plurality of non-proliferating Zymomonas mobilis (ZM) and a composite system comprising a plurality of non-proliferating Aspergillus japonicus (AJ) cells, thereby transforming the mono- and/or disaccharide of said starting juice to at least one oligo- and/or polysaccharide, a sugar alcohol, and a sugar acid.

According to yet additional aspect, the present invention provides a processed fruit or vegetable beverage produced by the process of the invention, wherein the processed beverage comprises at least one of sugar alcohol, a sugar acid, or a combination thereof transformed from the mono- and/or disaccharide of the starting juice, and wherein the total mono- and/or disaccharide sugar content in said proceed beverage is reduced by at least 5% compared to said starting juice.

According to certain embodiments, the processed juice further comprises at least one of oligosaccharide and/or polysaccharide.

It is to be understood that any combination of each of the aspects and the embodiments disclosed herein is explicitly encompassed within the disclosure of the present invention.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIGS. 1A-1B show a composite system comprising alginate as the anionic polymer (triplicate, FIG. 1A) and the composite system of the invention comprising carrageenan as the anionic polymer (FIG. 1B) used for sugar reduction in orange juice. Each system was incubated with the orange juice for one day (about 24 hours) and then transferred to 4° C. for 24 h, after which the pictures were taken.

FIG. 2 depicts sucrose, glucose, and fructose (SGF) reduction in a clear commercial orange juice at a flow rate of 1.2 L/hr.

FIG. 3A shows reduction of glucose and fructose out of the total amount of SGF in clear commercial orange juice using a combination of a composite system comprising Zymomonas mobilis (ZM composite system) and composite system comprising Aspergillus japonicus (AJ composite system) at a ratio of 50:50. The combination of glucose and fructose reduction depicts a combined production of sorbitol and gluconic acid (glucose+fructose=sorbitol+gluconic acid).

FIG. 3B depict sucrose reduction (squares) and sucrose reduction out of the total content of sucrose, glucose, and fructose, (SGF, circles) in a clear commercial orange juice, compared to the starting juice over time at a flow rate of 1.2 L/hr.

FIG. 3C depict glucose reduction (squares) and glucose reduction out of the total content of sucrose, glucose, and fructose, (SGF, circles) in a clear commercial orange juice, compared to the starting juice over time at a flow rate of 1.2 L/hr.

FIG. 3D depicts fructose reduction (squares), and fructose reduction out of the total content of sucrose, glucose, and fructose, (SGF, circles) in a clear commercial orange juice, compared to the starting juice over time at a flow rate of 1.2 L/hr.

FIG. 4A-B show HPLC analyses of two different batches of grape juice, after being processed by a composite system comprising Zymomonas mobilis (ZM) beads. FIG. 4A: batch designated “grape juice 1” FIG. 4B: batch designated “grape juice 2”.

FIG. 5A-B show HPLC analyses of two different batches of apple juice, after being processed by a composite system comprising ZM and Aspergillus japonicus (AJ) beads at a ratio of 70:30. FIG. 5A: batch designated “apple juice 1”. FIG. 5B: batch designated “apple juice 2”.

FIG. 6 shows HPLC analysis of concentrated strawberry juice after being processed by a composite system comprising ZM and AJ beads at a ratio of 90:10, respectively.

FIG. 7 shows HPLC analysis of pear juice after being processed by a composite system comprising ZM and AJ beads at a ratio of 80:20, respectively.

FIG. 8 shows HPLC analysis of tart cherry juice after being processed by a composite system comprising ZM and AJ beads at a ratio of 90:10, respectively.

FIG. 9 shows PLC analysis of orange juice after being processed by a composite system comprising ZM and AJ beads at a ratio of 50:50, respectively.

FIG. 10 shows HPLC analysis of pineapple juice after being processed by a composite system comprising ZM and AJ beads at a ratio of 50:50, respectively.

FIGS. 11A-11E show the effect of different composite systems: ZM100 (only ZM, squares), ZM and AJ beads at a ratio of 90:10 (ZM90:AJ10, dots), and 80:20 (ZM80:AJ20, triangles) on sucrose, glucose, fructose, total SGF reduction, and sorbitol production in apple juice over time. FIG. 11A, sucrose content over time (gr/100 gr juice). FIG. 11B, glucose content over time (gr/100 gr juice). FIG. 11C, fructose content over time (gr/100 gr juice). FIG. 11D, sorbitol production (gr/100 gr juice). FIG. 11E, total SGF reduction.

FIGS. 12A-12E show the effect of different composite systems: ZM100 (only ZM, squares), ZM and AJ beads at a ratio of 90:10 (ZM90:AJ10, dots), and 80:20 (ZM80:AJ20, triangles) on sucrose, glucose, fructose and total SGF reduction, and sorbitol production in orange juice over time. FIG. 12A, sucrose content over time (gr/100 gr juice). FIG. 12B, glucose content over time (gr/100 gr juice). FIG. 12C, fructose content over time (gr/100 gr juice). FIG. 12D, sorbitol production (gr/100 gr juice). FIG. 12E, total SGF reduction.

FIG. 13 shows the SGF reduction levels (%) in orange juice over 26 days using a 1.7% (dots) or a 3.4% (squares) ZM composite system.

FIG. 14 shows the total SGF reduction (squares), sucrose reduction (dots), and theoretical contribution of GFOR to reduction of glucose and fructose based on sorbitol formation (rhombus) in apple juice by a composite system comprising ZM and AJ beads at a ratio of 90:10, over 120 days at 0.54 L/hr at pH set point of 5.5 (days 0 to 92) and of 6.5 (days 93 to 114, boxed).

FIG. 15 shows glucose (dots) and fructose (triangle) reduction in apple juice by a composite system comprising ZM and AJ beads at a ratio of 90:10, over 120 days at 0.54 L/hr at pH set point of 5.5 (days 0 to 92) and of 6.5 (days 93 to 114 boxed).

FIG. 16 presents the total sucrose reduction (squares) and its contribution to total SGF reduction (dots) in apple juice by a composite system comprising ZM and AJ beads at a ratio of 90:10, over 120 days at 0.54 L/hr at pH set point of 5.5 (days 0 to 92) and of 6.5 (days 93 to 114, boxed).

### DETAILED DESCRIPTION OF THE INVENTION

The present invention answers a technical problem hindering the commercial use of enzymatically active non-proliferating microbial cells immobilized to a support for treating liquid product having a pH at a range that is lower compared to the pH required for efficient enzymatic activity, such that titration of the liquid to reach higher pH is required. The titration, typically performed with strong bases (e.g., potassium hydroxide, KOH) results in disaggregation/dissolving/disintegrating of the support matrices comprising commonly used polyelectrolytes, particularly alginate.

### Definitions

The singular forms “a”, “an”, and “the” include plural referents unless the context clearly dictates otherwise.

Unless the context clearly requires otherwise, throughout the specification, the words “comprise”, “comprising” and the like are to be construed in an inclusive sense as opposed to an exclusive or exhaustive sense; that is to say, in the sense of “including, but not limited to”.

The word “about”, as used in the specification, should generally be understood to refer to both numbers in a range of numerals, and refers to the numeral ±5%-±10%. Moreover, all numerical ranges herein should be understood to include each whole integer within the range.

As used herein, the term “substantially water-insoluble” or “water insoluble” with reference to the support of the present invention is to be understood as meaning that the support does not dissolve or disperse in water, particularly that at most 0.1% of the support weight may be dissolved or dispersed when said support is placed in water at a temperature of 25° C.

The term “non-proliferating microbial cells” as used herein refers to microbial cells that are found to be non-viable when examined in a viability test (e.g., growth in nutrient agar and strain specific growth plates, total or strain specific count <10 cfu/gr of beads). The microbial cells of the invention are dead microbial cells such as dead bacteria, dead fungi and/or dead yeast.

The terms “a plurality of enzymatically active non-proliferating microbial cells” and “enzymatically active agent” are used herein interchangeably and refer to a plurality of dead, non-proliferating microbial cells as defined hereinabove, which keep at least part of the enzymatic activities of corresponding living cells. According to certain exemplary embodiments, the dead microbial cells keep active enzymes associated with sugar metabolism. According to certain exemplary embodiments of the invention, the active enzyme is an enzyme using mono- and/or disaccharide as a substrate such that the overall content of the mono- and/or disaccharide present in a juice contacted with the enzymatically active agent is reduced. According to certain embodiments, the mono- or disaccharide is selected from the group consisting of glucose, fructose, and sucrose.

The terms “sugar” or “sugar content” as used herein refers to mono and/or disaccharide present within a vegetable or fruit juice, in particular to glucose or fructose or sucrose and/or their accumulative content of sucrose, and glucose, and fructose (SGF). The sugar content may be determined by any method known in the art. For non-limiting examples, a refractometer for the total sugar content measuring degrees Brix (1° Bx=1% sucrose=1 g of sucrose per 100 ml), or a High Performance Liquid Chromatography (HPLC) to quantify individual sugars such fructose, glucose, and sucrose may be used. Accordingly, as used herein, the terms “reducing sugar content” or “reduced sugar content” refer to the reduction of mono- and/or disaccharide sugars, particularly glucose, fructose, sucrose, or any combination thereof. The term “low sugar concentration” or “reducing the sugar concentration” refers to a concentration level of mono- and/or disaccharide sugars, particularly glucose, fructose, sucrose, or any combination thereof in a juice (treated) that is less than the respective sugar concentration level in a corresponding juice, which has not been contacted with/subjected to the composite system(s) of the present invention.

The term “sugar alcohol” as used herein refers to a chemical derivative derived from monosaccharides by the reduction of the aldehyde or ketone group to an alcohol group using, inter alia, glucose fructose oxidoreductase (GFOR-EC number 1.1.99.28) enzymes. Sugar alcohols are slowly and incompletely absorbed from the small intestine into the blood, consequently contribute fewer calories. Once absorbed they are converted to energy by processes that require little or no insulin. According to certain exemplary embodiments, the sugar alcohol is sorbitol.

According to some embodiments, the initial juice does not comprise detectable amount of sorbitol and the treated juice comprises detectable amounts of sorbitol. According to certain embodiments, the sorbitol content in the treated juice is elevated by at least 5%, 10%, 15%, 20%, 25%, 30%, 35%, 40%, 45%, 50%, 55%, 60%, 65%, 70%, 75%, 80%, 85%, 90%, and 95% or more compared to its content in the starting juice.

The term “gluconic acid” as used herein refers to the C1-oxidized form of D-glucose, where the aldehyde group has become oxidized using GFOR to the corresponding carboxylic acid. Gluconic acid is known in the food industry as an acidity regulator, thus may contribute to the stability of a food product. Furthermore, gluconic acid does not add any calories to the obtained food product (its calorie value is 0), and it may serve as a carrier for iron, calcium, and other ions, based on its capability to form gluconate salt with such ions, which may be present in the food product. The gluconate salts provide for better bioavailability of these essential microelements.

The term “Glucono-delta-lactone (GDL)” as used herein refers to the lactone of the gluconic acid. The enzyme glucose oxidase (GOX-EC number 1.1.3.4) is capable of transforming glucose to GDL, which partially hydrolyses in water to gluconic acid.

According to some embodiments, the initial juice does not comprise detectable amount of gluconic acid and the treated juice comprises detectable amounts of gluconic acid. According to certain embodiments, the gluconic acid content in the treated juice is elevated by at least 5%, 10%, 15%, 20%, 25%, 30%, 35%, 40%, 45%, 50%, 55%, 60%, 65%, 70%, 75%, 80%, 85%, 90%, and 95% or more compared to its content in the starting juice.

As used herein the term “dietary fiber” refers to a complex dietary component, including carbohydrate polymers and oligomers, which makes up the non-digestible components of food, particularly fruit, vegetable, and grains. All dietary fibers resist digestion in the small intestine and pass into the large intestine intact but differ in their physiochemical characteristics (e.g., solubility, viscosity, and fermentability), which determine their functionality in the gut and to what degree they are accessible by microbes. Most soluble fibers can be fermented by the gut microbiota, partially or completely, dependent on their chemical structure. Dietary fibers can be defined on the basis of their chemical compounds, on the basis of their functional compounds, or both. Slight differences in definitions of dietary fibers exist due to the wide range of non-digestible fibers that occur in nature. The European Food Safety Authority (EFSA) defines dietary fiber as “non-digestible carbohydrates plus lignin.” These include non-starch polysaccharides (NSP) cellulose, hemicelluloses, pectins, hydrocolloids (i.e., gums, mucilages, and β-glucans), digestion resistant oligosaccharides, digestion resistant starch (consisting of physically enclosed starch, some types of raw starch granules, retrograded amylose, chemically and/or physically modified starches), and lignin associated with the dietary fiber polysaccharides. According to certain exemplary embodiments, the term “dietary fibers” is used herein to refer to soluble fibers.

Fructans are fructose polymers produced by plants, yeasts, fungi, and bacteria and are considered dietary fibers. Fructans with a short chain length are known as fructooligosaccharides (FOS), whereas longer chain fructans are termed inulins or levans. FOS can be obtained by the transfructosylation action of the enzyme fructosyltransferase (FTase) on sucrose, sucrose fructosyltransferase (SFTase—EC number 2.4.1.99. FOS are composed of linear chains of fructose units, linked by beta (2-1) bonds, having the general formula of Glucose-Fructoseₙ (GFn). The number of fructose units ranges from 2 to 60 and often initiate with a glucose unit. Dietary FOS are not hydrolyzed by small intestinal glycosidases and reach the cecum structurally unchanged. There, they are metabolized by the intestinal microflora to form short-chain carboxylic acids, L-lactate, CO₂, hydrogen and other metabolites. FOS have a number of interesting properties, including a low sweetness intensity; they are also calorie free, non-cariogenic and are considered as soluble dietary fiber. Furthermore, FOS have important beneficial physiological effects such as a prebiotic effect, improved mineral absorption and decreased levels of serum cholesterol, triacylglycerols and phospholipids. FOS stimulate the growth of nonpathogenic intestinal microflora and increases fecal bolus and the frequency of defection (Sabater-Molina M et al., 2009. J Physiol Biochem. 65 (3): 315-28). FOSs are naturally produced by a large variety of microorganisms including, inter alia, Aspergillus japonicus (AJ).

According to certain embodiments, GFOR substrates are fructose and glucose, which are converted to D-glucitol and gluconolactone, typically non-enzymatically converted to sorbitol and gluconic acid, respectively.

According to certain embodiments the enzyme sucrose fructosyltransferase (SFTase) converts sucrose into fructo-oligosaccharides (FOS), or elongates FOS by adding a fructosyl group to a FOS molecule. According to certain embodiments, the enzyme GOX converts glucose to GDL which hydrolyses to gluconic acid.

According to certain embodiments, when the starting juice comprises sucrose, the composite systems of the invention provide for the production of oligo- and or -polysaccharide, particularly FOS, produced from the starting juice sucrose. According to certain embodiments, the treated juice comprises polysaccharide(s) at a concentration of from about 1 mg to about 10 gr per 100 ml juice (0.001% to 10% w/v). According to certain embodiments, the treated juice comprises from about 0.01%, about 0.05%, about 0.1%, about 0.5%, about 1% to about 10% polysaccharide(s). According to certain embodiments, the treated juice comprises from about 0.5% to about 2.5% polysaccharide(s).

According to certain aspects, the present invention provides a composite system comprising a plurality of enzymatically active non-proliferating microbial cells immobilized to a support, wherein the support is substantially water insoluble at 25° C. and comprises an anionic polymer comprising a polymeric backbone bonded to a plurality of negatively charged functional groups, selected from the group consisting of carboxylate, sulfate and sulfonate, and potassium countercations; wherein the potassium cations and the negatively charged functional groups are at a ratio of at least 1:2.

The present invention provides composite systems which are highly stable in a liquid environment subjected to constant titration with strong bases. As used herein, the term “stable” with regard to the composite systems of the invention refers to a composite system operable for at least 40, at least 50, or at least 60 days without visible degradation of the support and/or the appearance of sediments in the treated juice. The composite system of the present invention, advantageously, may be used within a bioreactor or other suitable system comprising juice in an operation cycle of at least 40, at least 50, or at least 60 days utilizing a single batch of said composite system. During an operation cycle, juice circulation within the system may cease for from about 12 hours to about 72 hours, in which the system may be cleaned, this cease is denoted on-hold/downtime.

According to certain embodiments, the support is in the form of a solidified hardened substantially water insoluble gel at 25° C.

According to certain embodiments, the anionic polymer solidifies in the presence of potassium cations to form the substantially water insoluble support.

The term “stable” further refers to maintaining the mechanical and/or chemical and/or activity (e.g., enzymatic activity) properties of the composite system of the invention over time under given pH and temperature in aqueous solution.

According to certain embodiments, the terms “mechanical stability” and/or “chemical stability” refer to the composite system and/or support maintaining its structure upon exposure to reactive substances, changes in pH, temperature variations, or interactions with other chemicals present in the environment. According to certain embodiments, the composite system and/or support upon exposure to reactive substances, changes in pH, temperature variations, or interactions with other chemicals present in the environment undergo disaggregation of less than 10%, 9%, 8%, 7%, 6%, 5%, 4%, 3%, 2% or 1%. According to certain embodiments, the composite system and/or support upon exposure to reactive substances changes in pH, temperature variations, or interactions with other chemicals present in the environment maintaining about 90%, 91%, 92%, 93%, 94%, 95%, 96%, 97%, 98% or 99% of its structure. According to certain embodiments, stability of the support of the composite system of the invention is maintained under the operable pH of the system. According to certain embodiments, the operable pH is in the range of 5 to 8. According to exemplary certain embodiments, the composite system and/or support, upon exposure to pH elevation in the juice environment by titration with a base, maintains about 90%, 91%, 92%, 93%, 94%, 95%, 96%, 97%, 98% or 99% of its structure.

Mechanical stability can be evaluated by any method known in the art for measuring crush strength, viscosity, and aspect ratio. Chemical stability can be evaluated by any method known in the art including measuring adsorbed water content, molecular weight (MW) and polydispersity index (PDI).

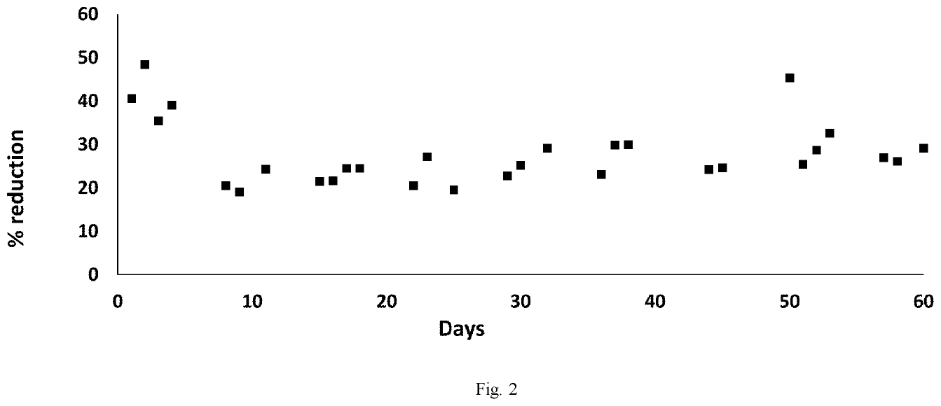

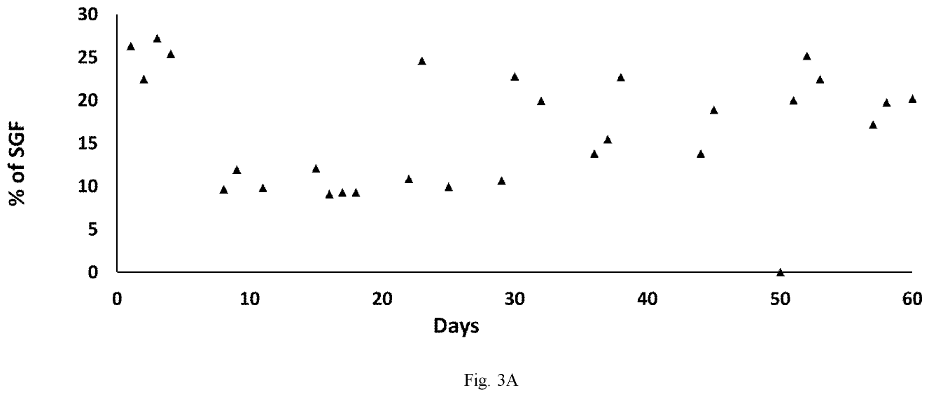

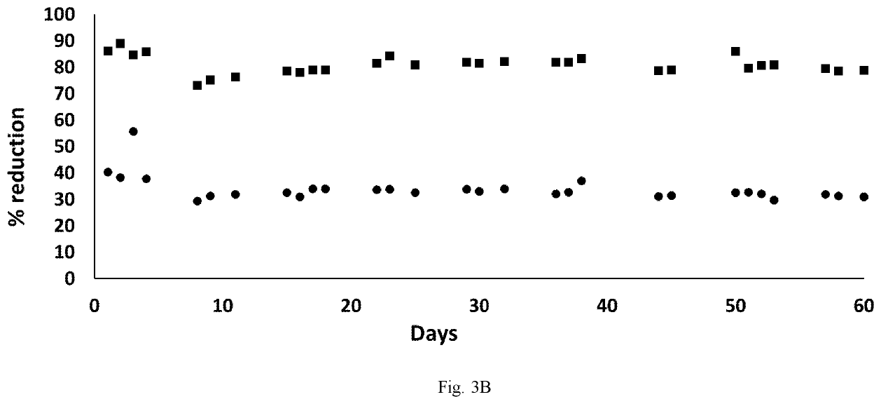

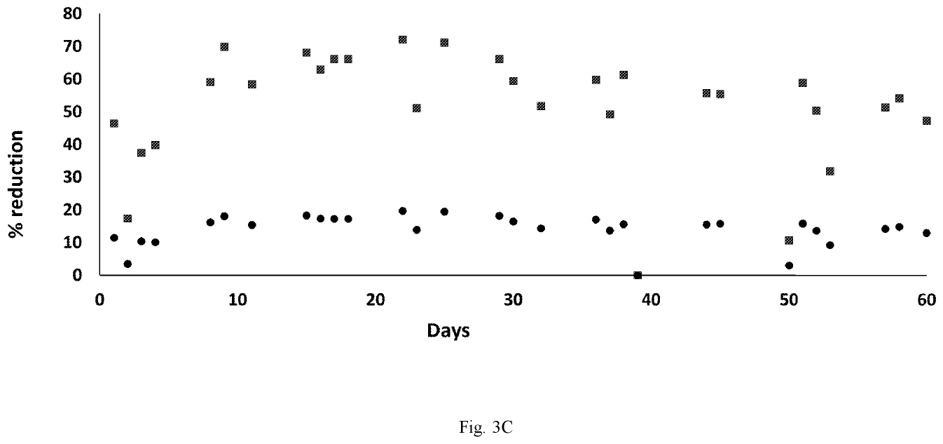

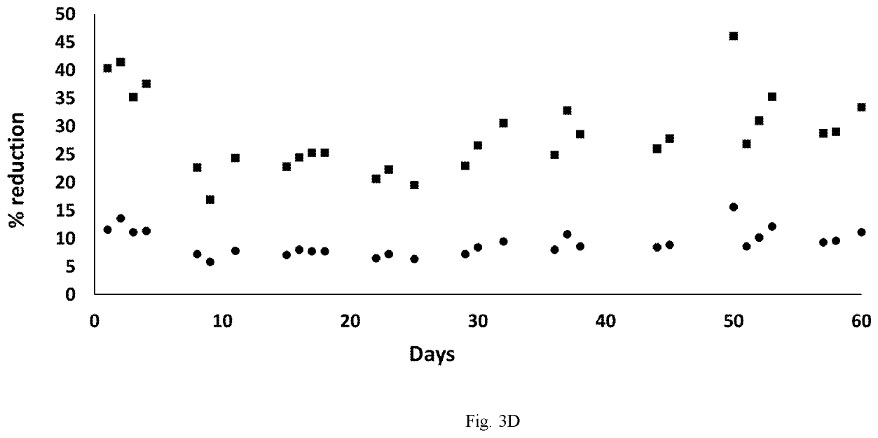

According to certain embodiments, the term “stable enzymatic activity” refers to specific activity maintained at at least 80% of the enzymatic activity measured after the system is operated for 7-10 days as can be seen in FIGS. 2-3D. According to certain embodiments, 7-10 days is the duration in which the system reaches balance.

According to certain embodiments, the composite system is stable at a temperature in the range of 4° C. to 40° C.

According to certain embodiments, the composite system is stable at a pH in the range of 5 to 8 at a temperature in the range of 4° C. to 40° C.

According to certain embodiments, the composite system is stable at pH in the range of 5 to 8 at 25° C. According to some embodiments, the composite system is stable at pH in the range of 5 to 7.5, 5 to 7.0, 5 to 6.5 or 5 to 6 at 25° C. According to some embodiments, the composite system is stable at pH in the range of 5.5 to 8, 5.5 to 7.5, 5.5 to 7.0, 5.5 to 6.5 or 5.5 to 6.0 at 25° C.

According to certain exemplary embodiments, the composite system is stable at pH in the range of 5 to 6 at 25° C.

According to certain embodiments, the composite system is in the form of beads.

The present invention covers a composite system, which may comprise a plurality of an anionic polymer as described hereinbelow (e.g., a plurality of polymer of the same spices and/or a plurality of polymer of different spices).

According to certain embodiments, the negatively charged functional groups comprise a plurality of sulfate groups. According to these embodiments, the anionic polymer comprises a plurality of potassium sulfate groups, at a weight ratio in the range of 20% to 40% w/w based on the total polymer weight.

According to certain embodiments, the polymeric backbone comprises a plurality of sugar monomers.

According to certain embodiments, the polymeric backbone comprises a plurality of monomers selected from the group consisting of: galactose monomers and anhydro galactose monomers.

According to certain embodiments, the anionic polymer is an anionic polysaccharide.

According to certain embodiments, anionic polysaccharide comprises a sulfate group per 1.5 to 2.5 sugar monomers.

According to certain embodiments, the anionic polymer is carrageenan. According to certain embodiments, the anionic polysaccharide is kappa carrageenan. The anionic polysaccharide of the present invention is other than alginate.

Carrageenan is a high molecular weight anionic linear hetero-polysaccharide obtained from marine algae, Rhodophyceae. It is a linear polysaccharide that consists of β-(1, 3)-sulphated-d-galactose and α-(1, 4)-3, 6-anhydro-d-galactose (3-crosslinked-). There are three main types of carrageenan based on the number and position of sulfate groups on the galactose/anhydrogalactose chain: kapa (κ), iota (ι) and gamma (λ)-Carrageenan, which contain one, two, and three sulfate groups per disaccharide repeating unit, respectively. κ-carrageenan molecules twist around each other and form double helical structures that can be cross-linked to form thermally reversible gels. In the presence of potassium ions, κ-carrageenan form strong and rigid thermoreversible gel. According to certain exemplary embodiments, the anionic polymer is kappa (κ)-carrageenan.

According to certain embodiments, the support further comprising a stabilizer, selected from the group consisting of: xanthan gum, gellan gum, and guar gum.

According to certain exemplary embodiments, the support comprises carrageenan and xanthan gum.

Encapsulation and/or immobilization of microbial cells is an efficient alternative for enzyme immobilization, providing a natural, water insoluble carrier system of required enzyme activities. As used herein, the term “immobilized” with reference to microbial cells and a support includes the terms “entrapped”, “encapsulated”, “embedded”, and “bonded”, which are used herein interchangeably and refer to microbial cells present within/on/bound to the support of the invention. The support of the present invention is an anionic polymer which is substantially water insoluble at 25° C.

Obtaining the dead microbial cells while preserving their enzymatic activity can be achieved by methods known in the art, for example, exposing the live microbial cells to heat, ethanol (EtOH), bile salts or bile-salt like compounds (e.g., sodium cholate); synthetic detergents (e.g., Tween 20, SDS, Triton X100); 200 ppm quaternary ammonium, aldehydes like glutaraldehyde or formaldehyde. The concentration of the solution for obtaining the dead microbial cells while preserving their enzymatic activity and the microbial cells density are determined according to the type of solution and the microbial cells, as is known to a person skilled in the Art. Some of the methods of obtaining the non-proliferating microbial cells could be performed before and/or after the microbial cells are immobilized within/in/to the polymer support of the invention. According to certain exemplary embodiments, obtaining the non-proliferating microbial cells is performed by exposing the microbial cells to EtOH or quaternary ammonium following their immobilization within/in/to the support

According to certain exemplary embodiments, killing the microbial cells is performed after the microbial cells are immobilized to/within the support anionic polymer, when the support is in a form of a bead. According to certain embodiments, the microbial cells immobilized to/within the support are killed by suspending the support beads comprising the immobilized microbial cells in 70% EtOH for 1 hr or quaternary ammonium for 1 hr or 0.5% glutaraldehyde for 15 min.

According to certain embodiments, the plurality of enzymatically active non-proliferating microbial cells comprises non-proliferating bacterial cells, non-proliferating fungal cells or a combination thereof.

According to certain embodiments, the plurality of enzymatically active non-proliferating microbial cells catalyzes a transformation of monosaccharides, disaccharides, or both into at least one of sugar alcohol, a sugar acid, an oligosaccharide, a polysaccharide, or a combination thereof. According to certain embodiments, the plurality of enzymatically active non-proliferating microbial cells catalyze a transformation of glucose, fructose, sucrose, or a combination thereof into at least one of sorbitol and gluconic acid. According to certain embodiments, the plurality of enzymatically active non-proliferating microbial cells catalyze a transformation of sucrose to fructooligosaccharides (FOS).

According to certain embodiments, the enzymatically active agent comprises a single species of a plurality of dead cells of bacteria, fungi and/or yeast. According to certain embodiments, the enzymatically active agent is a plurality of dead cells of Zymomonas mobilis (ZM). According to certain embodiments, the enzymatically active agent is a plurality of dead cells of Aspergillus japonicus (AJ). According to certain embodiments, the enzymatically active agent is a plurality of dead cells of Aspergillus niger (AN).

According to certain embodiments, the enzymatically active agent comprises a combination of distinct species of a plurality of dead cells of bacteria, fungi and/or yeast. According to certain embodiments, the enzymatically active agent is selected from the group consisting of a plurality of dead cells of Zymomonas mobilis (ZM), Aspergillus japonicus (AJ) Aspergillus niger (AN) and any combination thereof. According to certain embodiments, the plurality of enzymatically active non-proliferating microbial cells is selected from the group consisting of Zymomonas mobilis (ZM), Aspergillus japonicus (AJ) Aspergillus niger (AN) and any combination thereof.

According to certain embodiments, the plurality of enzymatically active non-proliferating microbial cells comprises an enzyme selected from the group consisting of cellulose synthase, glucosyltransferase, oxidoreductases, fructosyltransferase, glucose oxidase, glucose isomerase and any combination thereof.

According to certain embodiments, the plurality of enzymatically active non-proliferating microbial cells comprises an enzyme selected from the group consisting of glucose fructose oxidase reductase (GFOR), glucose oxidase (GOX), sucrose fructosyltransferase (SFTase) or a combination thereof.

According to certain embodiments, the enzymatically active ZM is capable of providing glucose fructose oxidoreductase (GFOR) enzymatic activity. According to certain embodiments, the enzymatically active AJ is capable of providing (sucrose fructosyltransferase) SFTase enzymatic activity. According to certain embodiments, the enzymatically active AN is capable of providing glucose oxidase (GOX) enzymatic activity.

According to certain aspect of the present invention there is provided a combination of at least two composite systems, wherein each of the composite systems comprises a plurality of enzymatically active non-proliferating microbial cells of a distinct species.

According to certain embodiments, the composite system may comprise only one type of enzymatically active agent. According to certain embodiments, the only one type of enzymatically active agent is ZM. According to alternative certain embodiments, the only one type of enzymatically active agent is AJ. According to alternative certain embodiments, the only one type of enzymatically active agent is AN.

According to certain alternative or additional embodiments, the composite system comprises a combination of at least two types of enzymatically active agents.

According to certain embodiments, the term “ZM active composite system” as used herein refers to a composite system, which comprises a plurality of dead ZM cells as the enzymatically active agent. According to certain embodiments, the term “AJ active composite system” as used herein refers to a composite system, which comprises a plurality of dead AJ cells as the enzymatically active agent. According to certain embodiments, the term “AN active composite system” as used herein refers to a composite system, which comprises a plurality of dead AN cells as the enzymatically active agent.

According to certain embodiments, the combination comprises a composite system comprising a plurality of non-proliferating Zymomonas mobilis (ZM) cells (ZM composite system) and a composite system comprising a plurality of non-proliferating Aspergillus japonicus (AJ) cells (AJ composite system).

According to certain embodiments, the ratio of ZM composite system to AJ composite system is the range of 60:40 to 90:10 w/w based on the total weight of the combination.

According to certain exemplary embodiments, the composite system has an enzymatic activity of GFOR. According to certain exemplary embodiments, the composite system having a GFOR activity is capable of converting glucose and fructose into gluconic acid and of glucose into sorbitol. According to certain exemplary embodiments, the composite system having GFOR activity comprises dead ZM cells and is capable of converting glucose and fructose into gluconic acid and of glucose into sorbitol.

According to certain further exemplary embodiments, the composite system has an enzymatic activity of SFTase. According to certain exemplary embodiments, the composite system having SFTase activity is capable of converting sucrose into FOS. According to certain exemplary embodiments, the composite system having SFTase activity comprises dead AJ cells and is capable of converting sucrose into FOS.

According to yet additional certain exemplary embodiments, the composite system has an enzymatic activity of glucose oxidase (GOX). According to certain exemplary embodiments, the composite system having GOX activity is capable of converting glucose into DGL, which hydrolyses to gluconic acid in water. According to certain exemplary embodiments, the composite system having GOX activity comprises dead AN cells and is capable of converting glucose into DGL.

Advantageously, the versatility of the composite systems of the invention provides for the ability to reduce the mono- and/or disaccharide content of any fruit or vegetable juice containing sugar. In certain embodiments, the present invention provides combinations of composite systems having different enzymatic agents and/or activities tailored according to the intrinsic sugar content of the juice to be processed and according to the desired characteristic of the processed juice. Any fruit or vegetable juice containing sugar can be processed according to the teachings of the present invention. Thus, the process is equally applicable to apple, cranberry, pear, peach, plum, apricot, nectarine, grape, cherry, currant, raspberry, gooseberry, blackberry, blueberry, strawberry, lemon, orange, grapefruit, potato, tomato, celery, rhubarb, carrot, beet, cucumber, pineapple, custard-apple, coconut, pomegranate, kiwi, mango, papaya, banana, watermelon, guava, passion fruit, and cantaloupe. Each possibility represents a separate embodiment of the present invention. According to some exemplary embodiments, the juice is of apple, pear, strawberry, orange, pineapple, grape or cherry. Each possibility represents a separate embodiment of the present invention.

According to certain embodiments, the composite systems of the inventions can be used for reducing the mono- and/or disaccharide content and elevating the sugar alcohol content in vegetable or fruit juice. Certain enzymatically active agents of the inventions are further capable of converting the juice disaccharide to dietary fibers, particularly to FOS.

According to certain exemplary embodiments, the composite system is for use in a process of at least one of (i) reduction of the glucose and/or fructose, and/or sucrose content of the natural fruit or vegetable juice, (ii) elevation of gluconic acid and/or sorbitol content of the natural fruit or vegetable juice, (iii) production/elevation of FOS within the fruit or vegetable juice; and any combination thereof.

According to some embodiments, the composite system is for use in a process of at least reduction of the glucose and/or fructose, and/or sucrose content of the natural fruit or vegetable juice, optionally elevation of gluconic acid and/or sorbitol content of the natural fruit or vegetable juice, further optionally production/elevation of FOS within the fruit or vegetable juice; and any combination thereof.

According to some embodiments, the juice is obtained from at least one type of fruit, vegetable, or any combination thereof. Any method as is known in the art for forcing the juice out of the source material and optionally for pre-treating the obtained natural juice before it is contacted with the enzymatically active composite system of the present invention can be used with the teachings of the present invention. According to some embodiments, the term “juice” encompasses any one of freshly squeezed juice, clear juice, nectar, juice concentrate, fruit drink, smoothie, puree, or any combination thereof. Each possibility represents a separate embodiment of the present invention.

As used herein, the terms “initial juice”, “starting juice” or “starting juice product” refer to the juice before being contact with/subjected to the composite system(s) of the present invention. The initial juice may be, but not limited to, a natural juice freshly squeezed, or extracted otherwise from a fruit or vegetable, or a juice after preliminary processing step(s), such as pulp removal, filtration(s), titrations, heat treatment(s) (e.g., pasteurization) and the like. The natural juice may have a consistency of liquid, suspended pulp, mash, slurry, or puree. The terms “treated juice”, “final juice”, or “processed juice” refer to the juice product obtained after being contact with/subjected to the composite system(s) of the present invention.

As used herein the term “initial total monosaccharide and disaccharide concentration”, “initial total monosaccharide and disaccharide content”, “initial total sugar concentration” or “initial sugar content”, which may be used interchangeably, refers to the sugar/monosaccharide and disaccharide content/concentration of initial fruit or vegetable juice/initial juice/starting juice/starting juice product.

The term “total sugar content” refer to the combination of sucrose content, glucose content and fructose content in a juice, unless specifically specified otherwise. It is to be understood that when referring to a percentage of the sucrose content, or glucose content, or fructose content out of the total sugar content as described hereinbelow, it is meant, for example, 10% fructose out of a total sugar content of 20% in the natural juice, that is 2% w/v out of the total volume of the juice.

According to some embodiments, the initial total monosaccharide and disaccharide concentration is in the range of 2% to 30% w/v out of the total volume of the juice, including each value and sub-range within the specified range.

According to some embodiments, the initial fruit or vegetable juice comprises an initial glucose concentration. According to some embodiments, the initial glucose concentration is in the range of 1% to 20% w/v out of the total volume of the juice, including each value and sub-range within the specified range.

According to some embodiments, the initial fruit or vegetable juice comprises an initial fructose concentration. According to some embodiments, the initial fructose concentration is in the range of 1% to 20% w/v out of the total volume of the juice, including each value and sub-range within the specified range.

According to some embodiments, the initial fruit or vegetable juice comprises an initial sucrose concentration. According to some embodiments, the initial sucrose concentration is in the range of 1% to 10% w/v out of the total volume of the juice, including each value and sub-range within the specified range.

According to certain embodiments, the sugar composition of the initial juice comprises from about 10% to about 90% fructose out of the total sugar content. According to certain embodiments, the sugar composition of the initial juice comprises from about 10%, about 20%, about 30% or about 40% to about 60%, about 70%, about 80% or about 90% fructose out of the total sugar content.

According to certain embodiments, the sugar composition of the initial juice comprises from about 10% to about 70% glucose out of the total sugar content. According to certain embodiments, the sugar composition of the initial juice comprises from about 10%, about 20%, about 30% or about 40% to about 60%, about 70%, about 80% or about 90% glucose out of the total sugar content.

According to certain embodiments, the sugar composition of the initial juice comprises from about 1% to about 70% sucrose out of the total sugar content. According to certain embodiments, the sugar composition of the sugar containing beverage comprises from about 1%, about 20%, about 30% or about 40% to about 60%, about 70%, about 80% or about 90% sucrose out of the total sugar content.

The mono- and or disaccharides of the initial juice (e.g., glucose and/or fructose and/or sucrose) are transformed to at least one of oligo- and/or polysaccharide (e.g., FOS), sugar alcohol (e.g., sorbitol), and gluconic acid, resulting in a treated (processed) juice comprises reduced content of at least glucose and/or fructose and/or sucrose compared to the content present in the starting juice, and optionally elevated content of FOS. Accordingly, the process involves contacting/subjecting the initial juice with/to the composite system(s) to at least reduce of the glucose and/or fructose, and/or sucrose content of the initial juice, optionally to elevate the content of gluconic acid and/or sorbitol content of the treated/processed juice, further optionally to elevate the content of FOS within the treated/processed juice; and any combination thereof. According to these embodiments, the process further comprises titrating the initial juice having a pH below 5.5 to a pH of about 7.0 throughout the process. It should be understood that throughout the process means for at least the time the juice is in contact/subjected to the composite system(s).

According to some embodiments the process further comprise downtime every weekend for about 12-72 h and clean-in-place cycle (CIP) of the bioreactor and its peripheral system twice a week for 12-24 hr. During downtime and CIP the composite system and juice within the bioreactor are kept at 4° C. Following every downtime and CIP the bioreactor, including the composite system(s) therein and the peripheral system are washed with a designated volume of fresh juice (starting juice) which is then discarded. After the designated wash volume is discarded the system is operated again and the starting juice is fed to the system and collected as processed juice.

According to certain embodiments, different types of composite systems, each comprises of distinct type of enzymatically active agent, providing a distinct enzymatic activity, can be used. According to certain embodiments, different ratios between different types of composite systems exert corresponding ratios of a distinct enzymatic activity. According to certain embodiments, the ratio between the different types of composite systems, each type having a distinct enzymatic activity, may be tailored according to the sugar content of the initial juice to be subjected to the combination of composite systems.

According to certain aspects, the present invention provides a combination of at least two composite systems, each composite system comprises a plurality of non-proliferating microbial cells of a single, distinct species. According to certain exemplary embodiments, the combination comprises two composite systems.

According to certain embodiments, the combination comprises a composite system comprising a plurality of dead microbial cells of Zymomonas Mobilis (ZM) and a plurality of dead microbial cells of Aspergillus japonicus (AJ).

According to certain embodiments, the combination comprises a composite system comprising a plurality of dead microbial cells of ZM and a composite system comprising a plurality of dead microbial cell of AJ.

According to certain embodiments the ratio between the ZM enzymatically active composite system and the AJ enzymatically active composite system (hereinafter “ZM:AJ ratio) is 90:10, or 80:20, or 70:30, or 60:40, or 50:50, or 40:60, or 30:70, or 20:80, or 10:90, respectively. Each possibility represents a separate embodiment of the present invention.

The composite system may be further sterilized by circulation/stirring in a solution of a food grade sterilizing and/or disinfecting agent. According to certain embodiments, the food grade sterilizing agent is a food grade quaternary ammonium compound. According to further certain exemplary embodiments, the quaternary ammonium compound is didecyldimethylammonium.

According to certain aspect of the present invention there is provided a process for reducing the content of at least one mono- and/or disaccharide in a fruit or vegetable juice comprising contacting a starting juice product with the composite system or the combination for at least 30 days thereby producing a processed juice having reduced content of at least one mono- and/or disaccharide compared to the starting juice product.

According to certain embodiments, the pH of the starting juice product is below 5.5 and the process further comprises titrating the juice to reach a pH of about 7.0 throughout the process. According to certain embodiments, the composite system is stable throughout the operation days. According to certain embodiments the mono- and/or disaccharide are converted to at least one of sugar alcohol (sorbitol) and sugar acid (gluconic acid) and optionally oligo and/or polysaccharide. According to certain embodiments, the processed juice further comprises a content of at least one of at least one sugar alcohol; gluconic acid; at least one oligosaccharide; and at least one polysaccharide compared to the starting juice product.

According to certain embodiments, the initial juice is subjected to/contacted with at least one composite system of the invention. According to certain embodiments, the initial juice is grape juice and it is contacted with ZM active composite system.

According to certain embodiments, the initial juice is apple juice and it is contacted with a combination of ZM active composite system and AJ active composite system at a ZM:AJ ratio of 90:10, or 80:20 or 70:30, or 60:40, or 50:50.

According to certain embodiments, the initial juice is strawberry juice and it is contacted with a combination of ZM active composite system and AJ active composite system at a ZM:AJ ratio of 90:10, or 80:20 or 70:30, or 60:40, or 50:50.

According to certain embodiments, the initial juice is pear juice and it is contacted with a combination of ZM active composite system and AJ active composite system at a ZM:AJ ratio of was 90:10, or 80:20 or 70:30, or 60:40, or 50:50.

According to certain embodiments, the initial juice is tart cherry juice and it is contacted with a combination of ZM active composite system and AJ active composite system at a ZM:AJ ratio of 90:10, or 80:20 or 70:30, or 60:40, or 50:50.

According to certain embodiments, the initial juice is orange juice and it is contacted with a combination of ZM active composite system and AJ active composite system at a ZM:AJ ratio of 90:10, or 80:20 or 70:30, or 60:40, or 50:50.

According to certain embodiments, initial juice is pineapple juice and it is contacted with ZM active composite system and AJ active composite system at a ZM:AJ ratio of 90:10, or 80:20 or 70:30, or 60:40, or 50:50.

According to certain embodiments, composite systems in the combinations described above are in the form of beads.

According to certain embodiments, the reduction of the mono- and/or disaccharides in the treated juice is at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 9%, or more, out of the total mono- and/or disaccharides in the starting juice.

According to certain embodiment, the reduction of total sucrose+glucose+fructose (SGF) content in the treated juice obtained by the process of the present invention is in the range of from about 5% to about 95% or more, or from about 10% to about 90%, or from about 20% to about 80%, to about 70%, to about 60%, to about 50%, to about 40% or to about 30% of the total SGF content in the starting juice.

According to certain embodiment, the total sucrose+glucose+fructose (SGF) content in the treated juice obtained by the process of the present invention is reduced by at least 5%, 10%, 15%, 20%, 25%, 30%, 35%, 40%, 45%, 50%, 55%, 60%, 65%, 70%, 75%, 80%, 85%, 90%, and 95% or more compared to the total SGF content in the starting juice.

According to some embodiments, wherein the starting juice comprises fructose, the reduction of fructose content in the treated juice is in the range of from about 5% to about 95% or more, or from about 10% to about 90%, or from about 20% to about 80%, to about 70%, to about 60%, to about 50%, to about 40% or to about 30% of its content in said starting juice.

According to some embodiments, wherein the starting juice comprises fructose, the fructose content in the treated juice is reduced by at least 5%, 10%, 15%, 20%, 25%, 30%, 35%, 40%, 45%, 50%, 55%, 60%, 65%, 70%, 75%, 80%, 85%, 90%, and 95% or more compared to its content in said starting juice.

According to some embodiments, wherein the starting juice comprises sucrose, the reduction of sucrose content in the treated juice is in the range of from about 5% to about 95% or more, or from about 10% to about 90%, or from about 20% to about 80%, to about 70%, to about 60%, to about 50%, to about 40% or to about 30% of its content in said starting juice.

According to some embodiments, wherein the starting juice comprises sucrose, the sucrose content in the treated juice is reduced by at least 5%, 10%, 15%, 20%, 25%, 30%, 35%, 40%, 45%, 50%, 55%, 60%, 65%, 70%, 75%, 80%, 85%, 90%, and 95% or more compared to its content in said starting juice.

According to some embodiments, wherein the starting juice comprises glucose, the reduction of glucose content in the treated juice is in the range of from about 5% to about 95% or more, or from about 10% to about 90%, or from about 20% to about 80%, to about 70%, to about 60%, to about 50%, to about 40% or to about 30% of its content in the starting food product.

According to some embodiments, wherein the starting juice comprises glucose, the glucose content in the treated juice is reduced by at least 5%, 10%, 15%, 20%, 25%, 30%, 35%, 40%, 45%, 50%, 55%, 60%, 65%, 70%, 75%, 80%, 85%, 90%, and 95% or more compared to its content in the starting food product.

According to some embodiments, wherein the starting juice comprises glucose and fructose, the elevation of sorbitol content in the treated juice is in the range of from about 5% to about 95% or more, or from about 10% to about 90%, or from about 20% to about 80%, to about 70%, to about 60%, to about 50%, to about 40% or to about 30% of its content in the starting food product.

According to some embodiments, the sorbitol content in the treated juice is elevated by at least 5%, 10%, 15%, 20%, 25%, 30%, 35%, 40%, 45%, 50%, 55%, 60%, 65%, 70%, 75%, 80%, 85%, 90%, and 95% or more compared to its content in the starting juice.

According to some embodiments, wherein the starting juice comprises SGF, the reduction of caloric content in the treated juice is in the range of from about 5% to about 95% or more, or from about 10% to about 90%, or from about 20% to about 80%, to about 70%, to about 60%, to about 50%, to about 40% or to about 30% of its content in the starting food product.

According to certain embodiments, the treated juice of the present invention may have a calorie content of less than 50%, 45%, 40%, 35%, 30%, 25%, 20%, 15%, 10% or less of the starting juice from which it is derived. At the same time, the reduced calorie treated juice may have a flavor profile and mouth feel which are comparable to the starting juice.

It is to be understood that no exogenous polysaccharides (e.g., FOS, dietary fibers), sugar alcohols or sugar acid is added to the juice at any stage of the process, and all are produced during the process of the present invention from the sugar content (i.e., sucrose, and/or glucose and/or fructose) naturally present in the initial juice.

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### EXAMPLES

### Material and Methods

### HPLC Protocol

### Equipment and Software:

LaChrom HPLC
EZChrom Elite
RI Detector
columns: (Column Size, Catalog Number) (Manufacturer):
BP-100 Al (50×4.6 mm, 1080-2) (Benson polymeric)
BP-100 Al (300×7.8 mm, 1080-0) (Benson polymeric)

### Method:

### Operating Conditions:

Eluent: DI H₂O
Flow Rate: 0.35 mL/min
Temperature: 50° C.
Sample Size: 10 μL,
Retention time, Window:
Nystose—Retention time: 14.22 min, Window: 0.68 min.
Kestose—Retention time: 14.87 min, Window: 0.71 min.
Sucrose—Retention time: 16.35 min, Window: 0.82 min.
Glucose—Retention time: 18.79 min, Window: 0.94 min.
Fructose—Retention time: 21.3 min, Window: 1.0 min.
Sorbitol—Retention time: 26.6 min, Window: 1.33 min.
Ethanol—Retention time: 31.93 min, Window: 1.6 min.

### Calibration Curves:

Nystose—slope: 14971867.09 [Area], y-intercept: −857593.2917 [Area].
Kestose—slope: 17341252.37 [Area], y-intercept: −1185289.875 [Area].
Sucrose—slope: 18409405.23 [Area], y-intercept: −150857.2667 [Area].
Glucose—slope: 18627911.87 [Area], y-intercept: −157885.3333 [Area].
Fructose—slope: 18128228.88 [Area], y-intercept: −170707.5333 [Area].
Sorbitol—slope: 17812425.4 [Area], y-intercept: −144196.3333 [Area].
LOWs: 6-0.375 sugars/100 mL

### Calibration Curve Examples for the Standards

| Calculated % | Sucrose |
|---|---|
| 0.375 | 6638397 |
| 0.75 | 13525892 |
| 1.5 | 27556971 |
| 3 | 56493665 |
| 6 | 115886208 |
| Factor 1% | 18258547.97 |
| Current 1% | 17916574 |
| Standard check | 98.13% |
| 0.375 | 6638397 |

$$[ Area ] - ( y - intercept ) [ Area ] / slop [ Area ] = amount [ gr ( sugar / 100 [ ml ] ) \qquad Equation 1$$

### Preceding Requirements:

Bring the column up to operating temperature before starting the pump.

### Materials: (Manufacturer, CAS Number)

### Standards:

Sucrose BioUltra, for molecular biology, >=99.5% HPLC (SIGMA-ALDRICH, 57-50-1).

D-(+)-Glucose BioUltra, anhydrous, >=99.5% HPLC sum of enantiomers (SIGMA-ALDRICH, 50-99-7).
D-(−)-Fructose BioUltra, ≥99.0% HPLC (SIGMA-ALDRICH, 57-48-7)
D-Sorbitol BioUltra, >=99.0% HPLC (SIGMA-ALDRICH, 50-70-4).
Nystose (SIGMA-ALDRICH, 133133 July 8).
1-Kestose (SIGMA-ALDRICH, 470-69-9).
Mobile phase (Eluent): DI H₂O.

### Consumables:

2ML CLEAR VIAL SNAP & cap slit 100 pk (VT011SM/C270CBS).

Syringe filter 13 mm Hydrophilic PVDF.45 μm 100PK (SFM13PVH0045).

### Standards Preparation:

Use sigma website (www.sigmaaldrich.com) Advanced Search to check PURITY in the Certificate of Analysis.

Prepare a 6% (60 mg/mL) solution of each of the sugars and use dilutions to prepare the additional concentrations (3, 1.5, 0.75, 0.375%).

Prepare 1% standards from all the sugars (Sucrose, Glucose, Fructose, Sorbitol).

### Calibration:

To identify the retention time of each of the sugars, run each of them separately, and then define in the software the location of each of the sugars.

Use the standards (3, 1.5, 0.75, 0.375%) and compare the percentage of each of the sugar standards in to the software output (area under each peak).

Use the standards and software output comparison to create a calibration curve for each of the sugars (this curve will be used to analyze the samples).

### Mode of Operation:

### Samples Preparation:

Filter between 0.5 and 1.5 mL to HPLC vial (if necessary, centrifuge at 4° C. 14000 rpm for 5 min).

Organize the vials in the autosampler.

Start the sequence. At the beginning of each sequence, run 1% sugars standard to verify accuracy followed by the samples.

After the sequences complete, the curve area for each pick is automatically obtained.

Sugar concentrations are presented in units of either gr/100 ml or percentage (1%=1 gr/100 ml).

### Example 1: Preparation of a Composite System Comprising Carrageenan as Anionic Polymer and Zymomonas mobilis (ZM-Carrageenan Composite System)

Preparation of carrageenan solutions (Mass—1.8 Kg)

132.5 g κ-carrageenan (powder, CPKelco ApS, GENUGEL carrageenan WR-78) and 1.7 g xanthan gum (powder, CPKelco, KELTROL T Plus) were mixed to homogeneity in a blender (60 sec×2, high speed) with 1802 g of hot water. The final concentrations of κ-carrageenan and xanthan gum were 1.5% and 0.08% w/w. Next, 1.53 kg of the homogenized solution was transferred into a 2 L bottle and heated for 30 min to 85-95° C. The heated solution was mixed, degassed, and cooled to 48° C.

### Preparation of ZM Solution

ZM suspension was prepared by mixing 145 g sediment ZM (fresh or frozen, as pellet) with 125 ml of water to reach 270 gr in total (~8% of the final mass) at 35° C. The suspension was dried and dry weight was determined. The required ZM amount was transferred to a new bottle (400 mL), according to the following formula: 30.6 g/dry weight %. Water was added to reach a total of 270 g, and the suspension was degassed.

### Combining the Carrageenan and ZM Solutions

ZM solution was gently added to the carrageenan solution mixed and degassed under vacuum, producing thereby a combined solution.

### Beads Formation

The combined solution was loaded to a peristaltic pump and dripping apparatus and dripped to a 2.5 L gelation bath at a single drop rate to allow beads formation. The gelation bath comprised 625 ml chitosan 0.25% in 1% acetic acid (Primex, ChitoClear® cg 1600) and 0.3M, 56 g/L KCl (Honeywell, Honeywell Fluka 12636) titrated to pH 5.2-6.0 with 50% KOH. After dripping has stopped, glutaraldehyde (50%, Sigma-aldrich, W512303) was added to reach a final concentration of ~0.5%, and the beads were stirred in the gelation bath for 15 min. Next, beads were washed 4 times with 0.3M KCl solution and drained, water and Divosan QC (quaternary ammonium, Diversy, Israel) were added to a final concentration of 400 ppm of Divosan QC.

The resulted composite system, comprising carrageenan as the anionic polymer and ZM as the enzymatically active non-proliferating microbial cells (“ZM composite system”) was kept at 4° C. until use.

### Viability Assessment

Validation of the non-viable status of the microbial cells within the composite system bead was performed using the following protocol:

### Equipment:

Incubator at 30° C. or 37° C.; Bio hood; Tissue grinder/homogenizer (autoclaved)-mortar and pestle; Spoon and tweezers; Spreaders

### Materials:

Beads to be tested and preserved in 70% ethanol; Sterile DW Nutrient agar plates (no antibiotics)

### Protocol Steps:

### (Sterile Work in Bio Hood)

1. Sterilize your gloves with ethanol.
2. Sterilize a spoon and tweezers ends with ethanol and flame.
3. Transfer 10-20 beads to the homogenizer mortar.
4. Transfer 2 ml water to the mortar and grind the beads to form a slurry.
5. Transfer 100 μl of the slurry to at least two culture plates comprising strain-specific growth medium and spread.
6. Place the plates in 30° C. and 37° C. incubators for 48-72 hr.

At the end of incubation time, count the colonies. Colony forming unit (CFU) of below 10 per gram per gr of beads taken in the beginning (CFU<10/gr) confirm non-viability of the microbial cells within the composite system.

### Example 2: Comparison of Alginate-Based Composite System and Carrageenan-Based Composite System

The inventors of the present invention has encountered the problem of their hitherto used composite system comprising alginate beads being unstable when used for treating fruit juice to reduce its sugar content and during its storage, specifically storage at the system downtime. Unexpectedly, using carrageenan as the anionic polymer solidified to form the support of the composite system provided for a physical as well as chemical stability of the system.

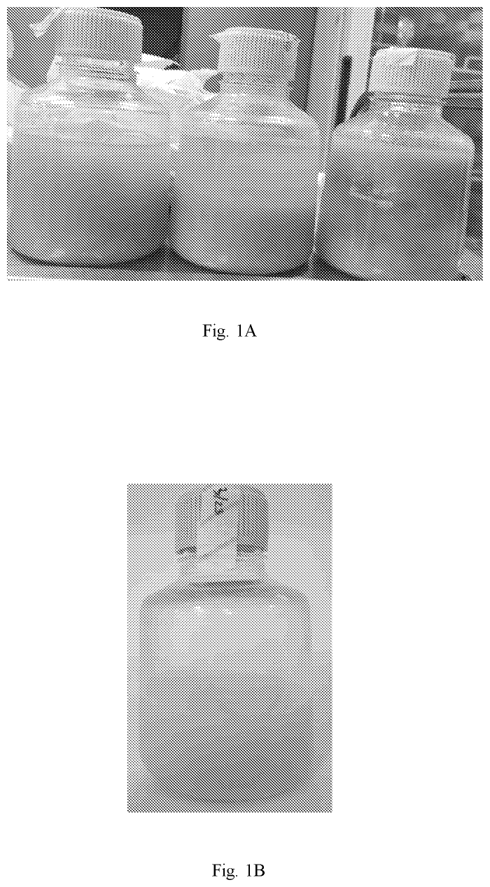

Comparison of a composite system comprising alginate as the anionic polymer (“alginate composite system”) and a composite system comprising carrageenan as the anionic polymer (“carrageenan composite system”) during treatment of orange juice is shown in FIGS. 1A-1B, respectively.

The carrageenan composite system was prepared as described in Example 1 hereinabove. The alginate composite system was prepared in the same manner with minor modifications. Alginate was used as the anionic polymer and gellan gum as the stabilizer, with a final concentration of alginate of 1.25% w/w and of gellan gum of 0.625% w/w. The homogenized solution was heated to a temperature of 80° C., and the heated solution was mixed, degassed, and cooled to 40° C.

Disaggregation of the alginate composite system (beads), a change in beads formation, and phase separation of the treated juice were observed during the process and even before reaching downtime (which includes incubation of the composite system in juice at 4° C.). Unexpectedly the carrageenan composite system (beads) kept intact, exhibiting chemical stability as no disaggregation of said composite system nor phase separation of the juice were visible.

As can be seen in FIG. 1A, the alginate composite system was highly unstable when used for treating orange juice, and a phase separation to beads sediments accumulating at the bottom of the bottle and clear juice at the top of the bottle was observed, indicating poor chemical stability. Surprisingly, the carrageenan composite system was chemically stable and exhibited chemical resistance, with no visible bead disaggregation and sedimentation.

### Example 3: Calibrating Protocol of the Enzymatic Activity of the Composite System of the Invention in SGF Buffer

To assess the enzymatic activity of the different composite systems with different enzymatically active agents in a buffer containing sucrose, glucose, and fructose (SGF buffer: filtered solution of 6% Sucrose, 3% glucose, 3% fructose, 3.6% Na₂HPO4, 0.9% NaH₂PO4 (w/w), at pH 7). 2 g AJ or 4 g ZM beads were placed in a tube, and 14 ml of the SGF buffer were added). Immediately upon addition of the SGF buffer to the tubes, 1 ml samples were collected from each tube and filtered. Next, the tubes were incubated for 20 min (AJ) or 1 h (ZM) at 30° C. At the end of incubation, 1 ml samples were collected. This process was repeated thrice. All samples were analyzed for sucrose, glucose, fructose, and sorbitol using HPLC as described in the materials and methods section. Activity is measured by the reduction of SGF in the samples over time. The composite system is considered enzymatically active if at the end of the incubation the concentration of the corresponding sugar is reduced by at least 2% and/or sorbitol concentration is at least 0.5%.

### Example 4: Calibrating Protocol of the Enzymatic Activity of the Composite System of the Invention in Orange Juice Standard

To assess the enzymatic activity of the different composite systems with different enzymatically active agents in orange juice standard, 0.5 g AJ or 1 g ZM beads were placed in a tube in a total volume of 2.5 ml water and vortexed until no clumps were visible. Next, 7.5 ml of 96% ethanol were added and vortexed further. Thereafter samples were incubated and tilted for 2 hr at 30° C. Following incubation, the samples were centrifuged at 4700 rpm, 4° C., for 5 min. The pellet was resuspended first with 1 ml water and vortexed; and then with an orange juice standard (orange juice from COJC, fresh prepared or sterile,° Bx 12 (11.8-12.2), pH 7 (6.9-7.1 with KOH). Next 1 ml sample was taken and placed in a 90° C.-95° C. water bath for 2 min heat shock. The rest of the tested suspension was kept tilted at 30° C. and samples were collected and heat shocked every 20 min (=0, 20, 40, 60) for AJ and every 1 hour for ZM (=0, 1, 2, 3). All samples were analyzed for sucrose, fructose, glucose, and sorbitol using HPLC as described in the materials and methods section. The composite system is considered enzymatically active if at the end of the incubation the concentration of the corresponding sugar is reduced by at least 2% and/or sorbitol concentration is at least 0.5%.

### Example 5: Calibration of the Large Scale Use of the Composite System

A total of 6 Kg of the composite system of the invention prepared as described in Example 1 hereinabove were loaded into a 10-liter bioreactor at a ratio of 50:50 of a composite system comprising ZM as the enzymatically active agent and a composite system comprising AJ as the enzymatically active agent (hereinafter “ZM:AJ ratio of 50:50). Orange juice with 12.0° Bx was used as the initial juice. The juice was tittered to PH~6 using 6.67 g/L of KOH, and continuously fed to the bioreactor. To determine the flow rate in which 30% of total Sucrose, Glucose, and Fructose (SGF) reduction is achieved, several feeding flow rates in the range of 1.2-3.0 L/hr were tested. The juice was constantly tittered to keep the pH at about 6 by a flow of the KOH titration solution maintained at a cycle rate of 3.5 L/hr. The juice was continuously fed into the bioreactor at the designated flow rate for 60 consecutive days, with a downtime every weekend for about 12-72 h and clean-in-place cycle (CIP) of the bioreactor and its peripheral system twice a week for 12-24 hr.

During the first week of the process, SGF reduction rate at a flow rate of 1.2 L/hr, was ~40% of the total SGF, at flow rate of 3 L/hr the reduction was about 20% and at a flow rate of 2.1 L/hr and the SGF reduction rate was about 25%.

FIG. 2 shows SGF reduction rate at a flow rate of 1.2 L/hr. After the first week of operation, a decrease in the total SGF reduction of about 25-30% was continuously observed. This result shows that the system is substantially stable for at least 60 days, after which the composite system was discarded. A flow rate of 1.2 L/hr was selected for further experiments.

FIG. 3A presents glucose and fructose conversion to sorbitol as a percent of SGF total content over time at Q=1.2 L/hr.

FIG. 3B presents sucrose reduction as % of SGF (circles) and of total sucrose in the starting juice (squares) over time at Q=1.2 L/hr.

FIG. 3C presents glucose change as % of SGF (circles) and of total glucose in the starting juice (squares) over time at Q=1.2 L/hr.

FIG. 3D presents fructose reduction as % of SGF (circles) and of total fructose in the starting juice (squares) over time at Q=1.2 L/hr.

It is to be noted that the variation observed in the percentage of SGF reduction can be related to the downtime and CIP cycles after which the enzymatic activity of the composite system needs to re-stabilize. Nevertheless, the sugar reduction process was operated in a highly stable manner throughout the 60 operational days examined.

As for the reduction of the total sugars presented in FIG. 2, FIGS. 3B-3D shows some decrease in the enzymatic activity after about one week; however, thereafter, the sucrose, glucose, and fructose (FIGS. 3B-3D, respectively) content was relatively constantly reduced up to the end of the experiment.

### Example 6: SGF Reduction is Grape Juice

Composite system beads comprising carrageenan and ZM (ZM composite system beads) were solely used in the grape juice assay. Juice was fed into the bioreactors at a flow rate of 1.2 L/h. The amount of sucrose, glucose, fructose, and other components within the fruit juice was measured by HPLC using the protocol described hereinabove. Two batches of grape juice denoted grape juice 1, and grape juice 2 were assayed. The corresponding untreated initial juice was used as control for each type of juice. The results are presented in Table 1 hereinbelow.

TABLE 1
SGF reduction and sorbitol production in grape
juice using ZM composite system beads

| | | | | | | SGF | % | % | |
|---|---|---|---|---|---|---|---|---|---|
| Juice | pH | Brix | Suc | Glu | Fru | sum | SGF | Red | Sor |
| Grape 1 | 3.35 | 22 | 0.06 | 8.10 | 8.19 | 16.35 | 100% | 0% | 0.03 |
| control | | | | | | | | | |
| pro- | 3.5 | 22 | 0.06 | 5.42 | 5.66 | 11.14 | 68% | 32% | 2.62 |
| cessed | | | | | | | | | |
| grape 1 | | | | | | | | | |
| Grape 2 | 3.61 | 17.5 | 0.00 | 7.74 | 8.53 | 16.27 | 100% | 0% | 0.02 |
| control | | | | | | | | | |
| pro- | 3.8 | 18.5 | 0.00 | 1.50 | 1.86 | 3.36 | 21% | 79% | 6.86 |
| cessed | | | | | | | | | |
| grape 2 | | | | | | | | | |

Sugar values are at g/100 mL. Sucrose (Suc), Glucose (Glu), Fructose (Fru), Reduction (Red), Sorbitol (Sor) Brix.

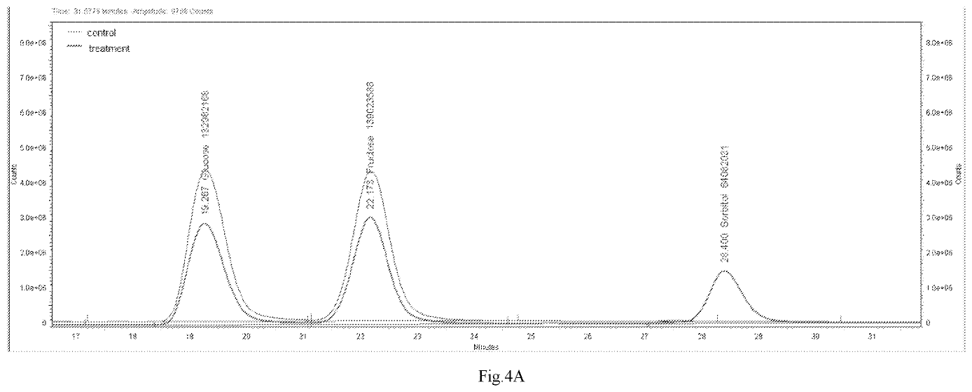

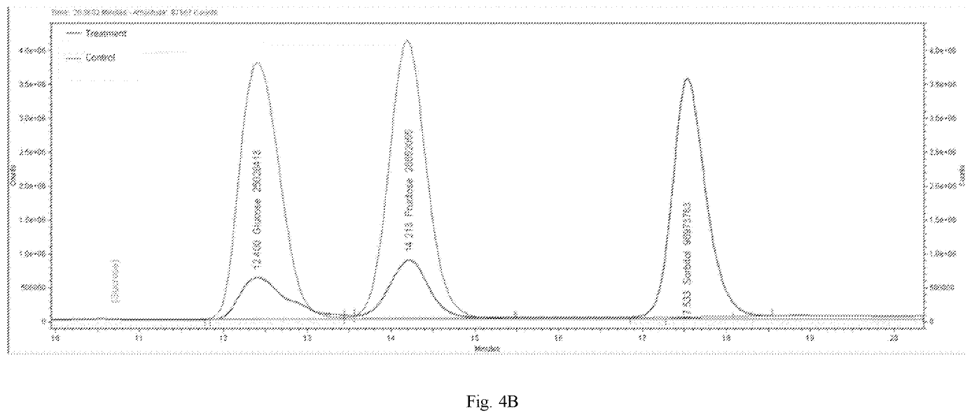

HPLC analyses are presented in FIG. 4A for the juice designated Grape 1 and in FIG. 4B for the juice designated Grape 2. Samples were taken after 24 h of beads contact with the juice.

### Example 7: SGF Reduction and Sorbitol Production in Apple Juice

### Short Term Assay (24 h)

A combination of ZN composite system beads and composite system beads comprising carrageenan and AJ (AJ composite system beads) at a ratio of 70:30 was used to examine sugar reduction and sorbitol production in two batches of apple juice (denoted apple juice 1, and apple juice 2). The amount of sucrose, glucose, fructose, and other components within the fruit juice was measured by HPLC using the protocol described hereinabove. The corresponding untreated initial juice was used as control for each type of juice. The results are presented in Table 2 hereinbelow.

TABLE 2
results of SGF reduction and sorbitol production
process of two different apple juice batches

| | | | | | | SGF | % | % | |
|---|---|---|---|---|---|---|---|---|---|
| Juice | pH | Brix | Suc | Glu | Fru | sum | SGF | Red | Sor |
| Apple 1 | 3.95 | 11 | 1.32 | 2.66 | 5.47 | 9.46 | 100% | 0% | 0.54 |
| control | | | | | | | | | |
| pro- | 3.96 | 11.2 | 0.34 | 2.21 | 3.8 | 6.36 | 67% | 33% | 1.98 |
| cessed | | | | | | | | | |
| apple 1 | | | | | | | | | |
| Apple 2 | 4.01 | 11.6 | 1.68 | 2.25 | 5.58 | 9.51 | 100% | 0% | 0.94 |
| control | | | | | | | | | |
| pro- | 4.14 | 13.2 | 0.08 | 0.00 | 2.69 | 2.77 | 29% | 71% | 4.34 |
| cessed | | | | | | | | | |
| apple 2 | | | | | | | | | |

Sugar values are at g/100 mL. Sucrose (Suc), Glucose (Glu), Fructose (Fru), Reduction (Red), Sorbitol (Sor) Brix.

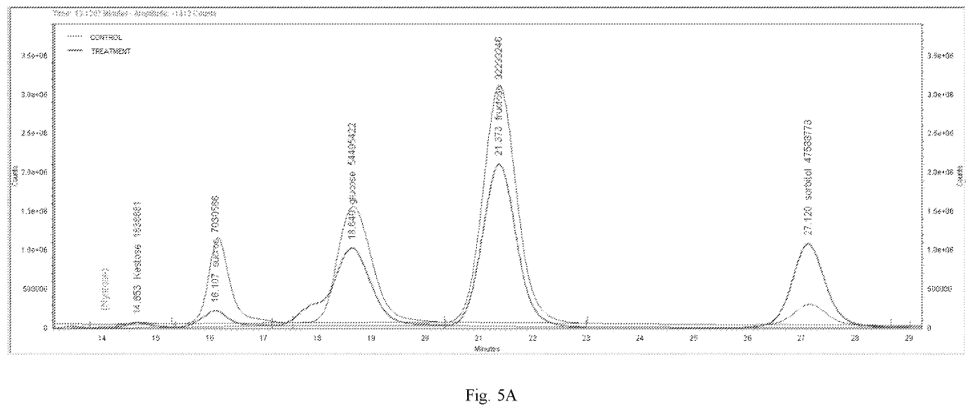

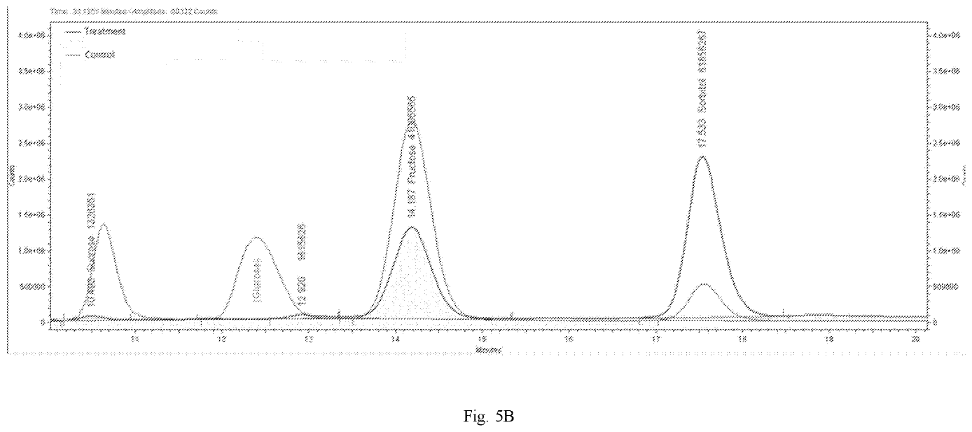

HPLC analyses are presented in FIG. 5A for the processed juice designated Apple 1 and in FIG. 5B for the juice designated Apple 2. Samples were taken after 24 h of contact of the combination of the composite systems with the juice.

### Effect of Composite System Combinations

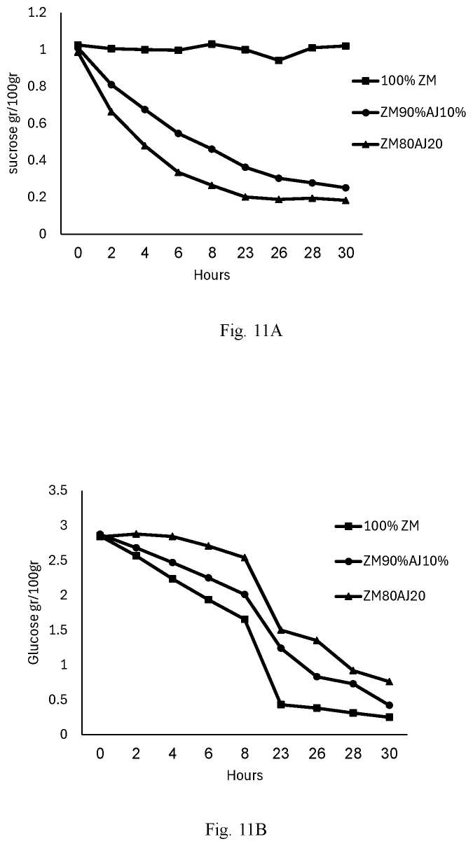

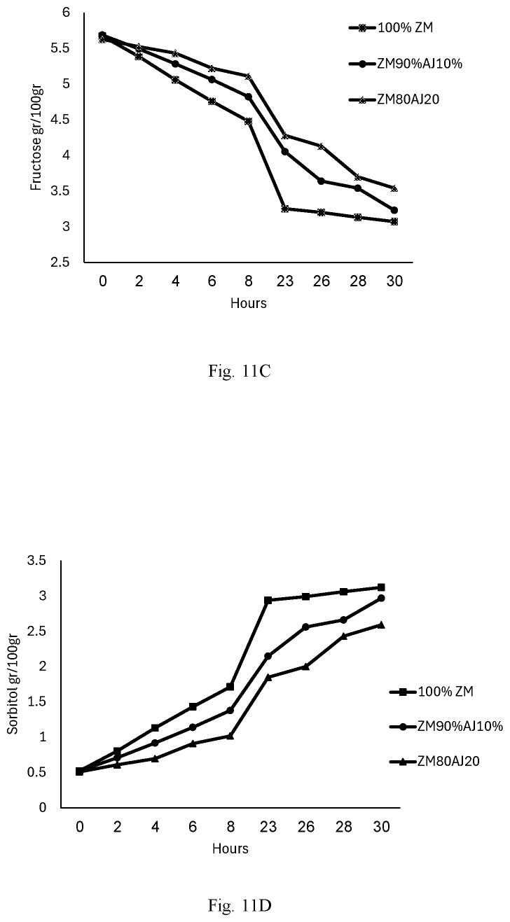

To evaluate the effect of different enzymatically active composite systems on the reduction of SGF and sorbitol production in apple juice, enzymatically active composite systems comprising a combination of ZM composite system beads and AJ composite system beads at a ratio of 100:0 (hereinafter ZM100), 90:10 (hereinafter ZM90:AJ10), and 80:20 (hereinafter ZM80:AJ20) were compared. The ZM and AJ beads were prepared as described in the material and method section. Each composite system was incubated for 30 hr. Samples were taken from the treated juice after 2, 4, 6, 8, 23, 26, 28, and 30 hours and analyzed by HPLC as described hereinabove for the SGF, sorbitol, and ethanol concentrations (gr/100 gr juice). Results for the sucrose, glucose, and fructose content (gr/100 gr apple juice), total SGF reduction (%) and sorbitol production (gr/100 gr apple juice) over time by ZM100 (squares), ZM90:AJ10 (dots), and ZM80:AJ20 (triangles) composite systems, are presented in FIGS. 11A-11E. FIG. 11A, sucrose content over time, depicting sucrose reduction. FIG. 11B, glucose content over time, depicting glucose reduction. FIG. 11C, fructose content over time, depicting fructose reduction. FIG. 11D, sorbitol production. FIG. 11E, total SGF reduction. The results are also summarized in Table 3.

TABLE 3
Results for the sucrose, glucose, fructose, total SGF
reduction (gr/100 gr apple juice), and sorbitol production
(gr/100 gr apple juice) over time by different composite
systems, ZM100, ZM90:AJ10, ZM80:AJ20
ZM100

| | Su- | | Fruc- | | SGF | SGF | SGF |
|---|---|---|---|---|---|---|---|
| Hours | crose | Glucose | tose | Sorbitol | sum | content | reduction |
| 0 | 1.02 | 2.85 | 5.67 | 0.52 | 9.55 | 100% | 0% |
| 2 | 1.01 | 2.56 | 5.38 | 0.81 | 8.96 | 94% | 6% |
| 4 | 1.00 | 2.24 | 5.06 | 1.13 | 8.29 | 87% | 13% |
| 6 | 1.00 | 1.94 | 4.76 | 1.43 | 7.69 | 81% | 19% |
| 8 | 1.03 | 1.65 | 4.47 | 1.72 | 7.16 | 75% | 25% |
| 23 | 1.00 | 0.43 | 3.25 | 2.94 | 4.68 | 49% | 51% |
| 26 | 0.94 | 0.38 | 3.20 | 2.99 | 4.52 | 47% | 53% |
| 28 | 1.01 | 0.31 | 3.13 | 3.06 | 4.45 | 47% | 53% |
| 30 | 1.02 | 0.25 | 3.07 | 3.12 | 4.34 | 45% | 55% |

| | | | | | | | |
|---|---|---|---|---|---|---|---|
| | Su- | | Fruc- | | SGF | SGF | SGF |
| Hours | crose | Glucose | tose | Sorbitol | sum | content % | reduction |

ZM90:AJ10

| | | | | | | | |
|---|---|---|---|---|---|---|---|
| 0 | 1.01 | 2.87 | 5.68 | 0.52 | 9.57 | 100% | 0% |
| 2 | 0.81 | 2.68 | 5.49 | 0.71 | 8.98 | 94% | 6% |
| 4 | 0.68 | 2.47 | 5.28 | 0.92 | 8.43 | 88% | 12% |
| 6 | 0.55 | 2.25 | 5.06 | 1.14 | 7.86 | 82% | 18% |
| 8 | 0.46 | 2.01 | 4.82 | 1.38 | 7.29 | 76% | 24% |
| 23 | 0.36 | 1.24 | 4.05 | 2.15 | 5.65 | 59% | 41% |
| 26 | 0.30 | 0.83 | 3.64 | 2.56 | 4.77 | 50% | 50% |
| 28 | 0.28 | 0.73 | 3.54 | 2.66 | 4.55 | 48% | 52% |
| 30 | 0.25 | 0.42 | 3.23 | 2.97 | 3.90 | 41% | 59% |

ZM80:AJ20

| | | | | | | | |
|---|---|---|---|---|---|---|---|
| 0 | 0.99 | 2.84 | 5.62 | 0.51 | 9.45 | 100% | 0 |
| 2 | 0.66 | 2.88 | 5.52 | 0.61 | 9.06 | 96% | 4% |
| 4 | 0.48 | 2.84 | 5.43 | 0.70 | 8.75 | 93% | 7% |
| 6 | 0.34 | 2.71 | 5.22 | 0.91 | 8.26 | 87% | 13% |
| 8 | 0.27 | 2.54 | 5.11 | 1.02 | 7.91 | 84% | 16% |
| 23 | 0.20 | 1.50 | 4.28 | 1.85 | 5.98 | 63% | 37% |
| 26 | 0.19 | 1.35 | 4.13 | 2.00 | 5.67 | 60% | 40% |
| 28 | 0.20 | 0.92 | 3.70 | 2.43 | 4.82 | 51% | 49% |
| 30 | 0.18 | 0.76 | 3.54 | 2.59 | 4.48 | 47% | 53% |

*No ethanol was detected during the process.

As can be seen in FIGS. 11A-11E and Table 3, all composite systems show significant production of sorbitol, a remarkable reduction of glucose and fructose, and accordingly SGF reduction in the ranges of 53-59%. The composite systems comprising a combination of enzymatically active agents (i.e., ZM90AJ10 and ZM80AJ20) also show a remarkable reduction in sucrose attributed to the specific enzymatic activity of the AJ.

### Example 8: SGF Reduction and Sorbitol Production in Concentrated Strawberry Juice

A combination of ZM composite system beads and AJ composite system beads at a ratio of 90:10 was used in this assay. One batch of strawberry juice was assayed. The amount of sucrose, glucose, fructose, and other components within the fruit juice was measured by HPLC using the protocol described hereinabove. The corresponding untreated initial juice was used as control for each type of juice. The results are presented in Table 4 hereinbelow.

TABLE 4
results of SGF reduction and sorbitol production
process of concentrated strawberry juice

| | | | | | | SGF | % | % | |
|---|---|---|---|---|---|---|---|---|---|
| Juice | PH | Brix | Suc | Glu | Fru | sum | SGF | Red | Sor |
| Strawberry | 3.39 | 44.9 | 3.07 | 12.49 | 14.33 | 29.89 | 100% | 0% | 0.37 |
| concentrated | | | | | | | | | |
| control | | | | | | | | | |
| Strawberry | 3.25 | 43.5 | 1.32 | 9.42 | 10.11 | 20.85 | 70% | 30% | 4.82 |
| concentrated | | | | | | | | | |
| processed | | | | | | | | | |

Sugar values are at g/100 mL. Sucrose (Suc), Glucose (Glu), Fructose (Fru), Reduction (Red), Sorbitol (Sor) Brix.

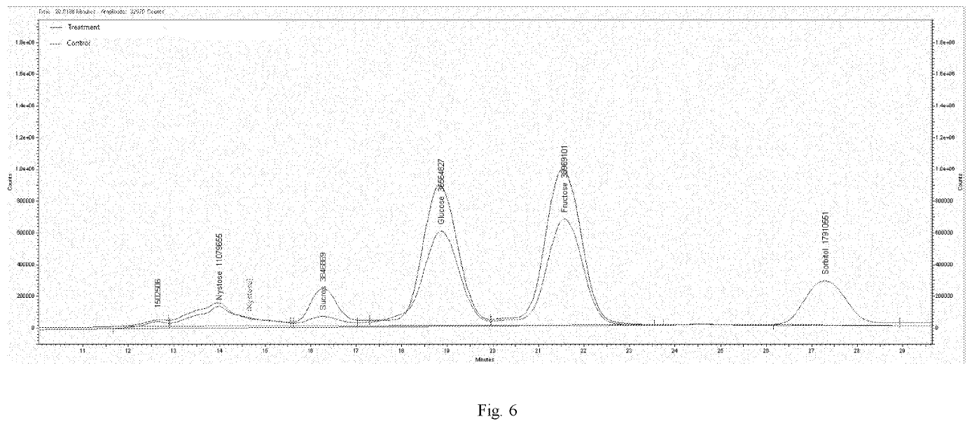

HPLC analysis is presented in FIG. 6. Samples were taken after 24 h of contact of the combination of the composite systems with the juice.

### Example 9: SGF Reduction and Sorbitol Production in Concentrated Pear Juice

A combination of ZM composite system beads and AJ composition beads at a ratio of 80:20 was used in this assay. The amount of sucrose, glucose, fructose, and other components within the fruit juice was measured by HPLC using the protocol described hereinabove. One batch of pear juice was assayed. The corresponding untreated initial juice was used as a control for each type of juice. The results are presented in Table 5 hereinbelow.

TABLE 5
results of SGF reduction and sorbitol production
process of concentrated pear juice

| | | | | | | SGF | % | % | |
|---|---|---|---|---|---|---|---|---|---|
| Juice | pH | Brix | Suc | Glu | Fru | sum | SGF | Red | Sor |
| Pear | 3.56 | 60 | 3.27 | 7.72 | 28.17 | 39.16 | 100% | 0% | 11.98 |
| concentrated | | | | | | | | | |
| control | | | | | | | | | |
| processed | 3.44 | 58 | 1.45 | 4.85 | 22.07 | 28.37 | 72% | 28% | 16.51 |
| Pear | | | | | | | | | |
| concentrated | | | | | | | | | |

Sugar values are at g/100 mL. Sucrose (Suc), Glucose (Glu), Fructose (Fru), Reduction (Red), Sorbitol (Sor) Brix.

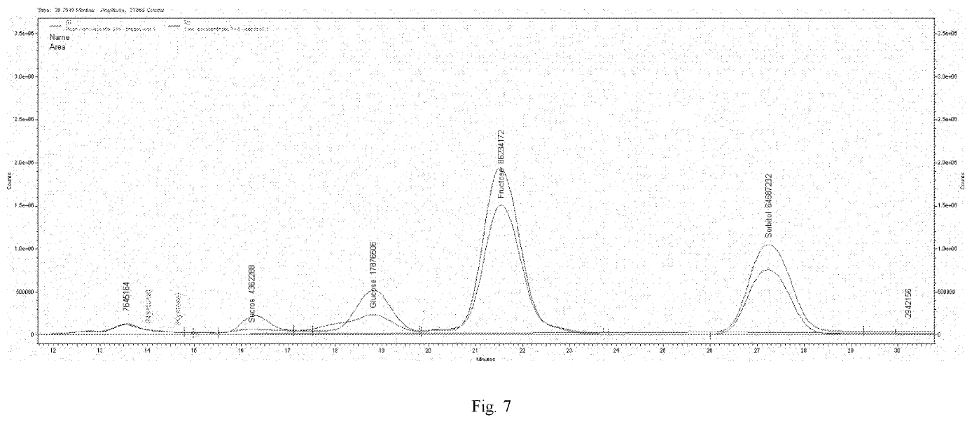

HPLC analysis is presented in FIG. 7. Samples were taken after 24 h of beads contact with the juice.

### Example 10: SGF Reduction and Sorbitol Production in Tart Cherry Juice

A combination of ZM composite system beads and AJ composite system beads at a ratio of 90:10 was used in this assay. The amount of sucrose, glucose, fructose, and other components within the fruit juice was measured by HPLC using the protocol described hereinabove. One batch of tart cherry juice was assayed. The corresponding untreated initial juice was used as a control for each type of juice. The results are presented in Table 6 hereinbelow.

TABLE 6
results of SGF reduction and sorbitol production process of tart cherry juice

| | | | | | | SGF | % | % | |
|---|---|---|---|---|---|---|---|---|---|
| Juice | pH | Brix | Suc | Glu | Fru | sum | SGF | Red | Sor |
| Tart | 3.4 | 30.4 | 0.67 | 9.5 | 8.45 | 18.61 | 100% | 0% | 5.55 |
| Cherry | | | | | | | | | |
| control | | | | | | | | | |
| processed | 3.55 | 29.6 | 0.62 | 4.46 | 3.70 | 8.78 | 47% | 50% | 10.60 |
| Tart cherry | | | | | | | | | |

Sugar values are at g/100 mL. Sucrose (Suc), Glucose (Glu), Fructose (Fru), Reduction (Red), Sorbitol (Sor) Brix.

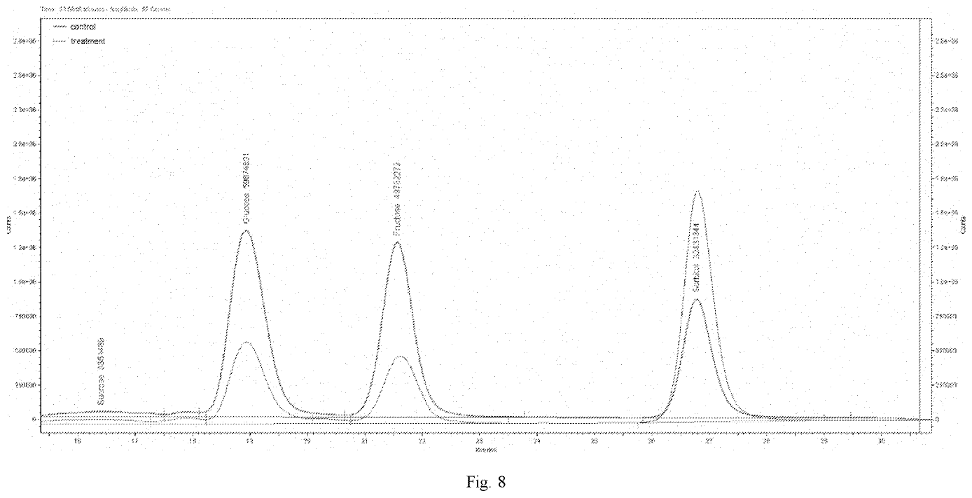

HPLC analysis presented in FIG. 8. Samples were taken after 24 h of beads contact with the juice.

### Example 11: SGF Reduction and Sorbitol Production in Orange Juice

### Short Term Assay

A combination of ZM composite system beads and AJ composite system beads at a ratio of 50:50 was used in this assay. The amount of sucrose, glucose, fructose, and other components within the fruit juice was measured by HPLC using the protocol described hereinabove. One batch of orange juice was assayed. The corresponding untreated initial juice was used as a control for each type of juice. The results are presented in Table 7 hereinbelow.

TABLE 7
results of SGF reduction and sorbitol production process of orange juice

| | | | | | | SGF | % | % | |
|---|---|---|---|---|---|---|---|---|---|
| Juice | pH | Brix | Suc | Glu | Fru | sum | SGF | Red | Sor |
| Orange | 3.75 | 10.7 | 3.60 | 2.34 | 2.56 | 8.50 | 100% | 0% | 0.04 |
| control | | | | | | | | | |
| processed | 3.79 | 10.5 | 1.46 | 2.58 | 1.82 | 5.86 | 69% | 31% | 0.89 |
| orange | | | | | | | | | |

Sugar values are at g/100 mL. Sucrose (Suc), Glucose (Glu), Fructose (Fru), Reduction (Red), Sorbitol (Sor) Brix

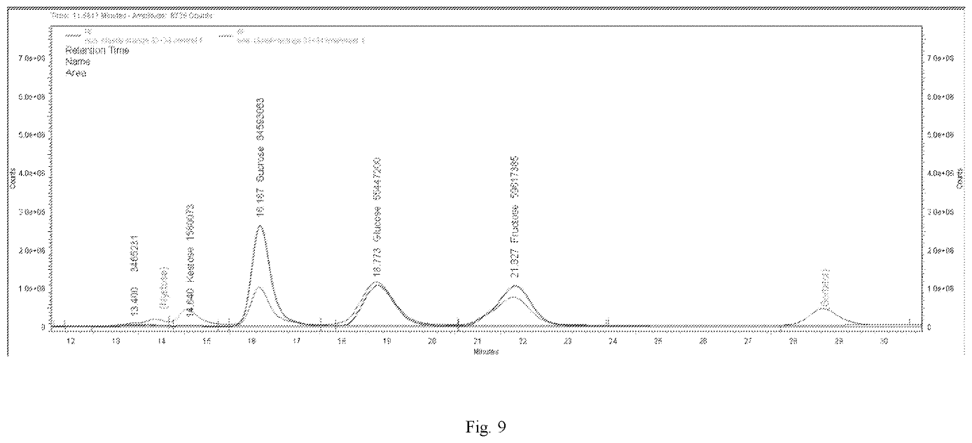

HPLC analysis is presented in FIG. 9. Samples were taken after 24 h of beads contact with the juice.

### Effect of the Concentration of the Enzymatically-Active Non-Proliferative Agent

To evaluate the effect of the concentration of the enzymatically-active non-proliferative microbial cells of the composite system on sugar reduction, ZM100 composite systems were prepared with 1.7% or 3.4% ZM. Each composite system was incubated for 24 hr at 4° C. with 2 L of orange juice tittered to pH~6.5 using 50% KOH for titration. SGF levels were measured every two hours, accordingly sugar reduction levels were calculated.

FIG. 13 presents a comparison of the SGF reduction levels (%) in orange juice over time using a 1.7% (dots) or a 3.4% (squares) ZM composite system.

As can be seen in FIG. 13, at every time point the SGF reduction levels using the 3.4% ZM composite system are higher than those of the 1.7% ZM composite system. After 24 hr the 3.4% ZM composite system SGF reduction levels reached ~73% while 1.7% ZM composite system SGF reduction levels reached ~60%. Indicating that SGF reduction in juice depends on the composite system concentration.

### Effect of Composite System Combinations

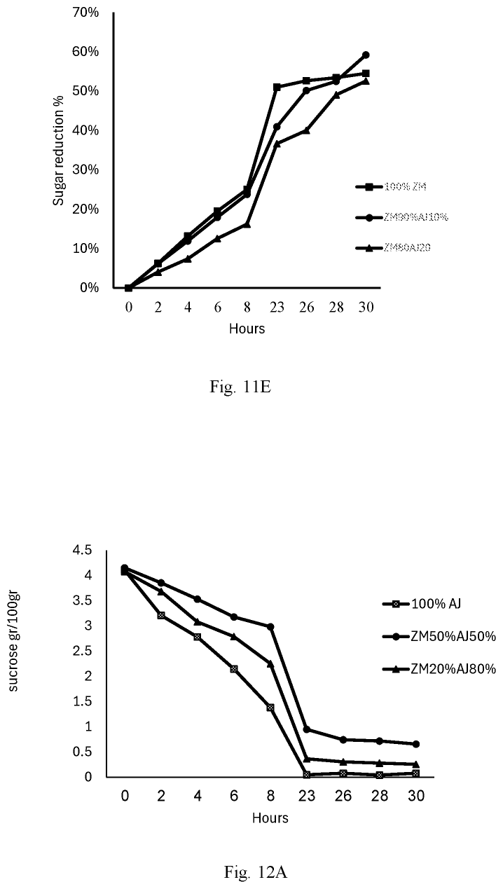

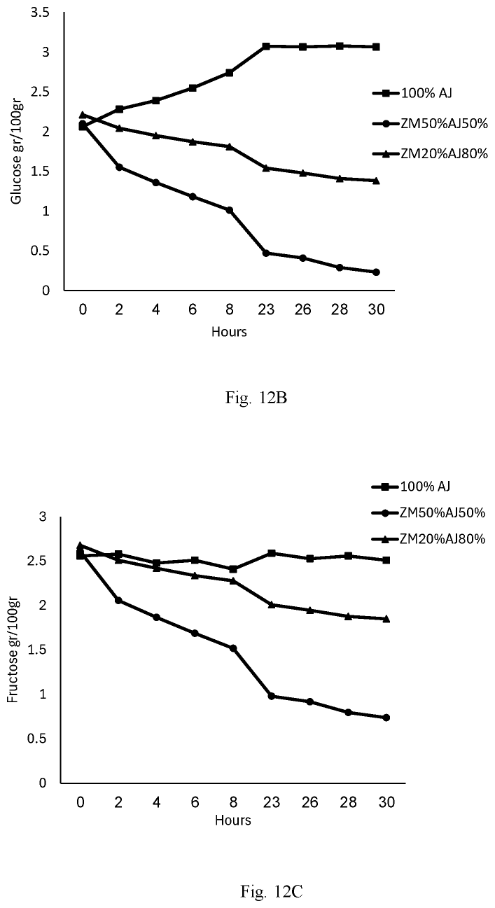

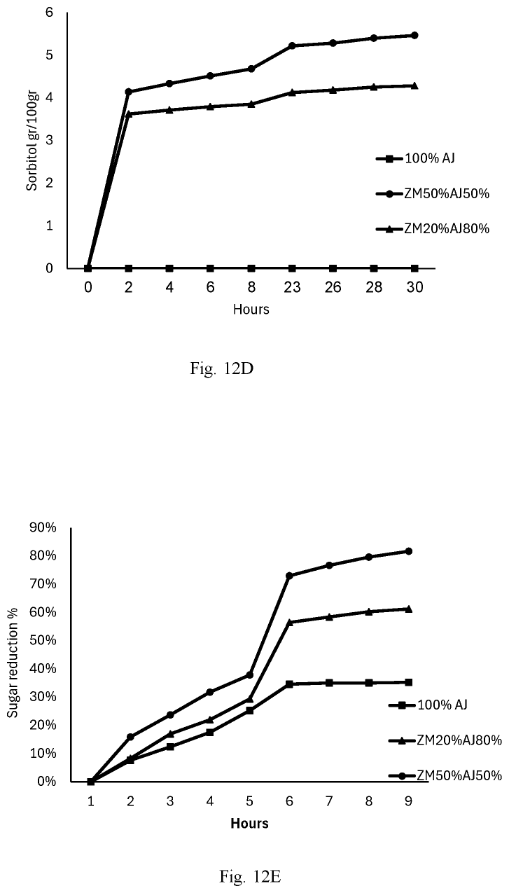

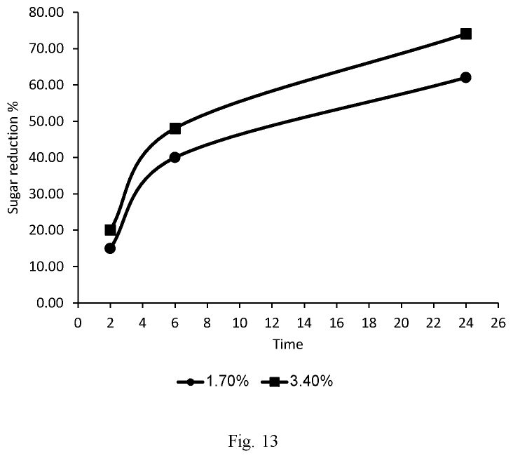

To evaluate the effect of different enzymatically active composite systems on the reduction of SGF and sorbitol production in orange juice, a combination of ZM composite system beads and AJ composite system beads at ZM:AJ beads ratio of 0:100 (hereinafter AJ100), 50:50 (hereinafter ZM50:AJ50), and 20:80 (hereinafter ZM20:AJ80) were compared. The ZM and AJ beads were prepared as described in the material and method section. Each composite system was incubated for 30 hr. Samples were taken from the treated juice after 2, 4, 6, 8, 23, 26, 28, and 30 hours and analyzed by HPLC for the SGF, sorbitol, and ethanol concentrations (gr/100 gr juice). Results for the sucrose, glucose, and fructose content (gr/100 gr orange juice), total SGF reduction (%) and sorbitol production (gr/100 gr apple juice) over time by AJ100 (squares), ZM90:AJ10 (dots), and ZM80:AJ20 (triangles) composite systems, are presented in FIGS. 12A-12E. FIG. 12A, sucrose content over time, depicting sucrose reduction. FIG. 12B, glucose content over time, depicting glucose reduction. FIG. 12C, fructose content over time, depicting fructose reduction. FIG. 12D, sorbitol production. FIG. 12E, total SGF reduction. The results are also summarized in Table 8.

TABLE 8
Results for the sucrose, glucose, fructose, total SGF
reduction (gr/100 gr apple juice), and sorbitol production
(gr/100 gr apple juice) over time by different composite
systems, ZM100, ZM90:AJ10, ZM80:AJ20

| | | | | | | | |
|---|---|---|---|---|---|---|---|
| | Su- | | Fruc- | | SGF | SGF | SGF |
| Hours | crose | Glucose | tose | Sorbitol | sum | content % | reduction |

AJ100

| | | | | | | | |
|---|---|---|---|---|---|---|---|
| 0 | 4.11 | 2.06 | 2.56 | 0.00 | 8.73 | 100% | 0% |
| 2 | 3.21 | 2.28 | 2.58 | 0.00 | 8.07 | 92% | 8% |
| 4 | 2.78 | 2.39 | 2.48 | 0.00 | 7.65 | 88% | 12% |
| 6 | 2.15 | 2.55 | 2.51 | 0.00 | 7.21 | 83% | 17% |
| 8 | 1.38 | 2.74 | 2.41 | 0.00 | 6.53 | 75% | 25% |
| 23 | 0.05 | 3.07 | 2.59 | 0.00 | 5.71 | 65% | 35% |
| 26 | 0.08 | 3.07 | 2.53 | 0.00 | 5.68 | 65% | 35% |
| 28 | 0.04 | 3.08 | 2.56 | 0.00 | 5.68 | 65% | 35% |
| 30 | 0.08 | 3.07 | 2.51 | 0.00 | 5.66 | 65% | 35% |

ZM50:AJ50

| | | | | | | | |
|---|---|---|---|---|---|---|---|
| 0 | 4.15 | 2.10 | 2.61 | 0.00 | 8.86 | 100% | 0% |
| 2 | 3.85 | 1.55 | 2.06 | 4.14 | 7.46 | 84% | 16% |
| 4 | 3.53 | 1.36 | 1.87 | 4.33 | 6.76 | 76% | 24% |
| 6 | 3.18 | 1.18 | 1.69 | 4.51 | 6.05 | 68% | 32% |
| 8 | 2.98 | 1.01 | 1.52 | 4.68 | 5.51 | 62% | 38% |
| 23 | 0.95 | 0.47 | 0.98 | 5.22 | 2.40 | 27% | 73% |
| 26 | 0.74 | 0.41 | 0.92 | 5.28 | 2.07 | 23% | 77% |
| 28 | 0.72 | 0.29 | 0.80 | 5.40 | 1.81 | 20% | 80% |
| 30 | 0.66 | 0.23 | 0.74 | 5.46 | 1.63 | 18% | 82% |

ZM20:AJ80

| | | | | | | | |
|---|---|---|---|---|---|---|---|
| 0 | 4.08 | 2.21 | 2.68 | 0.00 | 8.97 | 100% | 0% |
| 2 | 3.68 | 2.04 | 2.51 | 3.62 | 8.23 | 92% | 8% |
| 4 | 3.08 | 1.95 | 2.42 | 3.71 | 7.45 | 83% | 17% |
| 6 | 2.79 | 1.87 | 2.34 | 3.79 | 7.00 | 78% | 22% |
| 8 | 2.25 | 1.81 | 2.28 | 3.85 | 6.34 | 71% | 29% |
| 23 | 0.36 | 1.54 | 2.01 | 4.12 | 3.91 | 44% | 56% |
| 26 | 0.30 | 1.48 | 1.95 | 4.18 | 3.73 | 42% | 58% |
| 28 | 0.28 | 1.41 | 1.88 | 4.25 | 3.57 | 40% | 60% |
| 30 | 0.25 | 1.38 | 1.85 | 4.28 | 3.48 | 39% | 61% |

*No ethanol was detected during the process.

As can be seen in FIGS. 12A-12E and Table 8, all composite systems show a remarkable reduction in SGF content in the range of 35%-82%%. The composite systems comprising a combination of enzymatically active agents (i.e., ZM50AJ50 and ZM20AJ80) show a remarkable reduction in sucrose, glucose, and fructose, and a remarkable increase in sorbitol content. The AJ100 composite system shows a significant, decrease in sucrose levels, and an increase in glucose levels, while fructose levels remain essentially the same. As noted above the SGF levels in the AJ100-treated orange juice decreased over time by 35%.

### Example 12: SGF Reduction and Sorbitol Production in Pineapple Juice

A combination of ZM composite system beads and AJ composite system beads at a ratio of 50:50 was used. One batch of pineapple juice was assayed. The amount of sucrose, glucose, fructose, and other components within the fruit juice was measured by HPLC using the protocol described hereinabove. The corresponding untreated initial juice was used as control for each type of juice. The results are presented in Table 9 hereinbelow.

TABLE 9
results of SGF reduction and sorbitol production process of pineapple juice

| | | | | | | SGF | % | % | |
|---|---|---|---|---|---|---|---|---|---|
| Juice | pH | Brix | Suc | Glu | Fru | sum | SGF | Red | Sor |
| Pineapple | 3.77 | 12.7 | 3.16 | 2.43 | 2.48 | 8.08 | 100% | 0% | 0.00 |
| control | | | | | | | | | |
| processed | 3.98 | 14.1 | 0.24 | 1.08 | 1.22 | 2.54 | 31% | 69% | 4.42 |
| Pineapple | | | | | | | | | |

Sugar values are at g/100 mL. Sucrose (Suc), Glucose (Glu), Fructose (Fru), Reduction (Red), Sorbitol (Sor) Brix

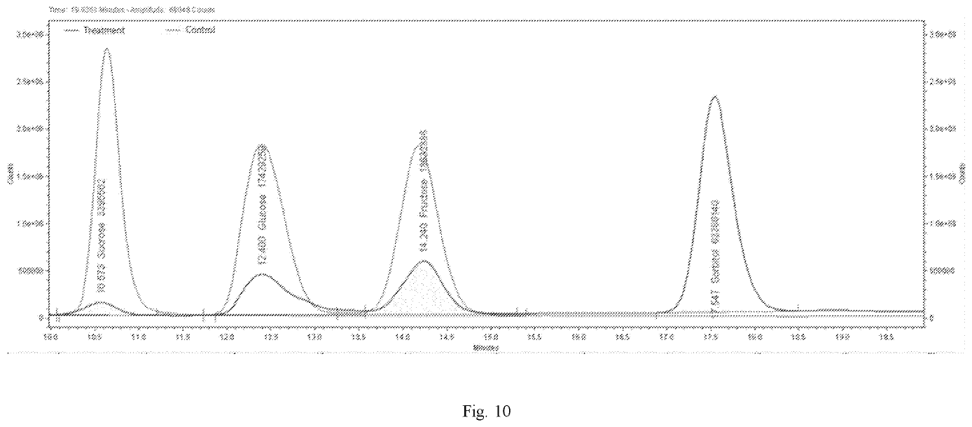

HPLC analysis is presented in FIG. 10. Samples were taken after 24 h of beads contact with the juice.

### Example 13: Dietary Fibers and FOS Production in Orange Juice

FOS concentration was determined by Eurofins Food Testing Netherlands B.V. (Eurofins). To that end a combination of ZM composite system beads and AJ composite system beads at a ratio of 50:50 was used. Total fructan (inulin for example) was measured by HPLC according to Eurofins routine method HEC3D (AOAC 999.03), a method suitable for samples with high sugar content. Total dietary fiber (DF) was measured by HPLC according to Eurofins routine method HEC4F (AOAC2017.16). Results for the FOS and Dietary fibers (% w/w) measurements of two batches of treated orange juice are depicted in table 10.

TABLE 10
HPLC analyses of DF and FOS in treated orange juice

| | | sample 1 | sample 2 | sample 1 | sample 2 | sample 1 | sample 2 |
|---|---|---|---|---|---|---|---|
| | t = 0 h | t = 8 h | t = 8 h | t = 15 h | t = 15 h | t = 24 h | t = 24 h |
| | HEC3D results | | | | | | |
| Inulin-FOS | <0.2 | 1.2 | 1.3 | 1.2 | 1.2 | 1.0 | 0.9 |
| | HEC4F results | | | | | | |
| Total Dietary | — | 1.1 | 1.1 | 1.0 | 0.9 | 0.7 | 0.7 |
| Fibers (TDF) | | | | | | | |
| Low molecular | <0.1 | 1.1 | 1.1 | 1.0 | 0.9 | 0.7 | 0.7 |
| weight Dietary | | | | | | | |
| Fibers (SDFS) | | | | | | | |
| High molecular | <0.2 | <0.2 | <0.2 | <0.2 | <0.2 | <0.2 | <0.2 |
| weight DF | | | | | | | |
| (IDF + SDFS) | | | | | | | |

TDF (Total Dietary Fibers (DF))=High Molecular Weight DF (HMWDF)+Soluble DF (SDFS) where,
HMWDF=IDF (Insoluble DF)+SDFP=[Insoluble+Soluble HMWDF]=Total HMWDF

The method employed quantitates the water-insoluble dietary fiber (IDF) separately from water-soluble dietary fiber (SDF), including the dietary fiber that precipitates (SDFP) in the presence of 78% aqueous ethanol or industrial methylated spirits (IMS), and the dietary fiber that remains soluble (SDFS).

### Example 14: Activity of the Composite System Over Long Operating Time

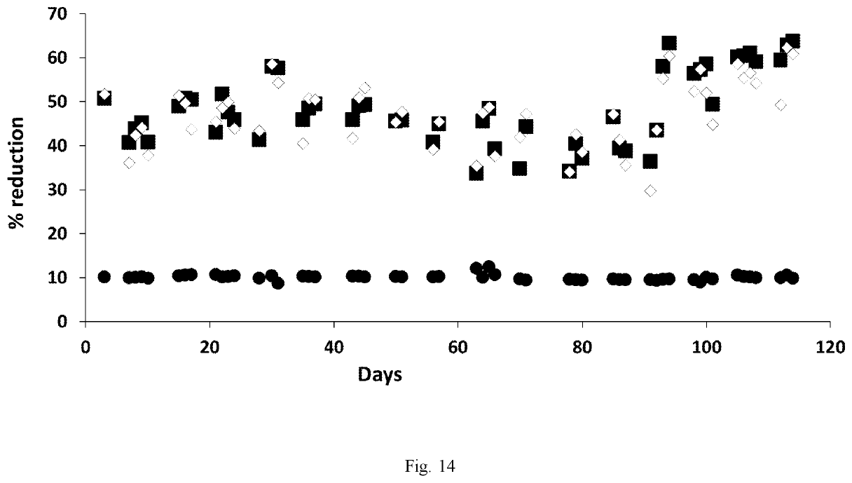

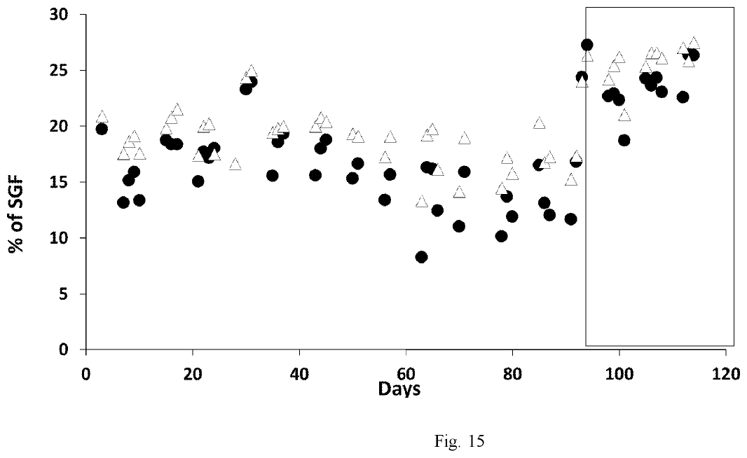

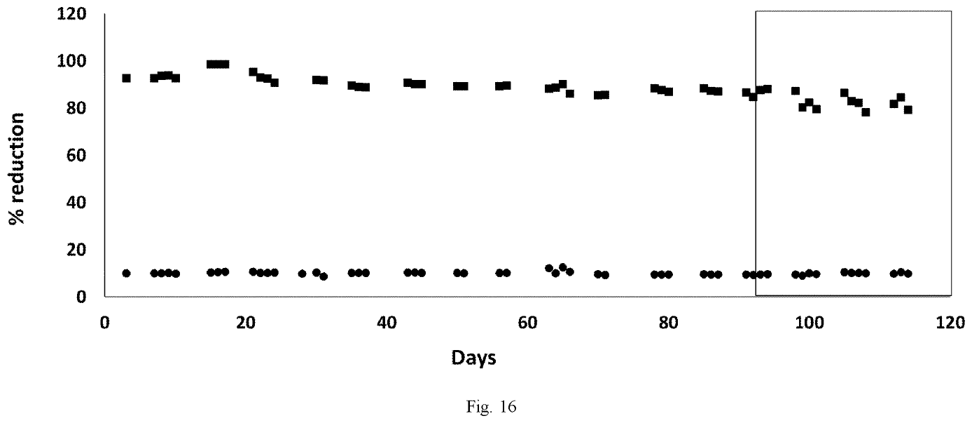

The activity levels (i.e., SGF reduction and sorbitol production) of a composite system combination comprising ZM composite system beads and AJ composite system beads at a ratio of 90:10 were determined for over 90 days. To that end a total of 5.0 Kg of the composite system bead combination were loaded into a bioreactor. For the starting juice single-strength apple juice at 11.5° Bx was prepared daily from apple concentrate, titrated to pH of 5.5 on days 0 to 92 and pH 6.5 on days 93 to 114. The starting juice was pumped into the system at a flow rate of 0.52-0.54 L/hr. The temperature within the bioreactor was kept at 30° C. During the 114 days of the experiment, the bioreactor and its peripheral system was subjected to clean-in-place cycle (CIP) twice every week, where the apple juice was replaced by quaternary ammonium solution with 0.06M KCl, while the composite system combination was kept in place. Further during the experiment, there were several downtimes in which 1-2 g/L of methylparaben was added to the juice and kept circulating within the system. The sucrose, glucose, fructose, and sorbitol levels were monitored at different time points. FIG. 14 presents the total SGF reduction (squares), sucrose reduction (dots), and theoretical contribution of GFOR to glucose and fructose reduction based on sorbitol formation (rhombus) over time at 0.54 L/hr at pH set point of 5.5 (days 0 to 92) and 6.5 (days 93 to 114, boxed). FIG. 15 presents glucose (dots) and fructose (triangle) reduction over time at 0.54 L/hr at pH set point of 5.5 (days 0 to 92) and 6.5 (days 93 to 114, boxed). FIG. 16 presents the total sucrose reduction (squares) and its contribution to total SGF reduction (dots).

It is to be noted that the theoretical reduction of glucose and fructose (GFOR activity considers the formation of one sorbitol molecule and a resulting formation of one gluconic acid molecule is coupled to the reduction of one glucose molecule and one fructose molecule.

As can be seen in FIGS. 14-16, using the composite system combination comprising ZM and AJ at a 90:10 ratio, about 50% reduction of total SGF was observed from the beginning of the trial, of which ~10% was sucrose, and ~20% each of the glucose and fructose. Sorbitol was formed accordingly. The composite system activity remained stable till day 78, which included several downtimes and was not affected by it. After day 78 a decrease in activity was observed, and SGF reduction dropped to ~40% and even lower. At day 92 when the pH was set at 6.5 an increase to 60% total SGF reduction was observed and kept stable up to day 114.

The enzymatically active composite system was not removed, discarded, replaced and/or refilled for the entire duration of the experiment (120 days), not even during downtimes or for the system's cleaning procedure (CIP). Remarkably, the composite system kept comparable activity levels (i.e., sucrose, glucose, fructose, total SGF reduction, and sorbitol production) for the entire duration of the experiment. Only a small adjustment in the set point of the pH was needed after 92 days. It is to be noted that the re-gain of activity level is not due to microbial contamination originated from the starting juice (which is only pasteurized and not sterile), since no EtOH production was observed. The absence of EtOH indicates that the elevated activity levels (i.e., sucrose, glucose, fructose, total SGF reduction, and sorbitol production) are indeed a result of increased enzymatic activity due to the higher operational pH.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

1. A composite system comprising a plurality of enzymatically active non-proliferating microbial cells immobilized to a support, wherein the support is substantially water insoluble at 25° C. and comprises:
an anionic polymer comprising a polymeric backbone bonded to a plurality of negatively charged functional groups, selected from the group consisting of: carboxylate, sulfate and sulfonate, and potassium counter cations;
wherein the potassium cations and the negatively charged functional groups are at a ratio of at least 1:2.

2.-36. (canceled)

37. The composite system of claim 1, wherein the support is in the form of a solidified hardened substantially water insoluble gel at 25° C.

38. The composite system of claim 1, wherein the anionic polymer solidifies in the presence of potassium cations to form the substantially water insoluble support.

39. The composite system of claim 1, wherein the negatively charged functional groups comprise a plurality of sulfate groups, wherein the anionic polymer comprises a plurality of potassium sulfate groups, at a weight ratio in the range of 20% to 40% w/w based on the total polymer weight.

40. The composite system of claim 1, wherein the anionic polymer is an anionic polysaccharide, wherein the anionic polysaccharide comprises one sulfate group per 1.5 to 2.5 sugar monomers.

41. The composite system of claim 1, wherein the anionic polysaccharide is carrageenan.

42. The composite system of claim 41, wherein the anionic polysaccharide is kappa carrageenan.

43. The composite system of claim 1, wherein the support further comprises a stabilizer selected from the group consisting of xanthan gum, gellan gum and guar gum.

44. The composite system of claim 1, wherein the support comprises carrageenan and xanthan gum.

45. The composite system of claim 1, wherein said composite system is in the form of beads.

46. The composite system of claim 45, wherein at least 90% of the beads maintain their form within a solution having a pH in the range of from about 5 to about 8 and a temperature of 0° C. to 65° C.

47. The composite system of claim 46, wherein at least 90% of the beads maintain their form within a solution having a pH in the range of from about 5 to about 8 and a temperature of from 20° C. to 30° C. for at least two months; and wherein at least 90% of the beads maintain their form within a solution having a pH in the range of from about 5 to about 8 and a temperature of from 0° C. to 8° C. for at least six months.

48. The composite system of claim 1, wherein the plurality of enzymatically active non-proliferating microbial cells comprises non-proliferating bacterial cells, non-proliferating fungal cells or a combination thereof.

49. The composite system of claim 1, wherein the plurality of enzymatically active non-proliferating microbial cells catalyzes a transformation of monosaccharides, disaccharides, or a combination thereof into at least one of sugar alcohol, a sugar acid, an oligosaccharide, a polysaccharide, or a combination thereof.

50. The composite system of claim 1, wherein the plurality of enzymatically active non-proliferating microbial cells comprises microbial cells selected from the group consisting of Zymomonas mobilis (ZM), Aspergillus japonicus (AJ), Aspergillus niger (AN) and any combination thereof.

51. The composite system of claim 1, wherein at least 90% of the beads are stable within a solution having a pH in the range of 5 to 8 at a temperature of up to 37° C.

52. The composite system of claim 1, wherein at least 90% of the beads are stable within a solution having a pH in the range of from about 5 to about 8 and a temperature of from 20° C. to 30° C. for at least two months.

53. A combination of at least two composite systems of claim 1, wherein each of the composite systems comprises a plurality of enzymatically active non-proliferating microbial cells of a distinct species, wherein said combination comprises a composite system comprising a plurality of non-proliferating Zymomonas mobilis (ZM) cells (ZM composite system) and a composite system comprising a plurality of non-proliferating Aspergillus japonicus (AJ) cells (AJ composite system).

54. A process for reducing the content of at least one mono- and/or disaccharide in a fruit or vegetable juice comprising contacting a starting juice product with the composite system of claim 1 for at least 30 operation days, thereby producing a processed juice having reduced content of at least one mono- and/or disaccharide compared to the starting juice product.

55. The process of claim 54, wherein the pH of the starting juice product is below 5.5 and wherein the process further comprises titrating the juice to reach a pH of from about 5.5 to about 7.0 throughout the process.
